(19) United States
(12) Patent Application Publication
(10) Pub. No.: US 2002/0165782 A1
(43) Pub. Date: Nov. 7, 2002

(54) Method, system and software for inventory management

(75) Inventors: Gary F. Falkenstein, Boulder, CO (US); Norbert Fischer, Teximo Morelos (MX); Daniel A. DeLeeuw, Superior, CO (US)

Correspondence Address: FOLEY AND LARDNER, SUITE 500, 3000 K STREET NW, WASHINGTON, DC, 20007, US

(73) Assignee: Fischer USA Inc.

(21) Appl. No.: 10/076,958

(22) Filed: Feb. 19, 2002

Related U.S. Application Data
(60) Provisional application No. 60/268,867, filed on Feb. 16, 2001.

(51) Int. Cl. G06F 17/60

(52) U.S. Cl. 705/22; 705/8

(57) ABSTRACT

A computer implemented method, system, and software that tracks inventories of a time period sensitive item on a time period basis. A demand for the time period sensitive item for each time period in a time interval is generated. A production plan for producing a source item that produces the time period sensitive item for each time period in the time interval is generated. The source item generates the time period sensitive item over various time periods in the time interval. The time period sensitive items are reserved for the established demand on a time period basis. The time period sensitive items include vegetative cuttings and plug seedlings.

### CROSS-REFERENCE TO RELATED APPLICATIONS

This application claims the benefit of priority under 35 U.S.C. §119(e) of provisional application serial No. 60/268,867 entitled “Method, System and Software For Inventory Management,” filed on Feb. 16, 2001, the disclosure of which, including all its appendices, is incorporated herein in its entirety.

### BACKGROUND OF THE INVENTION

1. Field of the Invention

This invention relates generally to the field of software and systems that manage the inventory for products that are time period sensitive (or have a short shelf life) and have the need to be matched with sales and/or distribution on a time period basis.

2. Background of the Related Art

Because of the uniqueness of the inventories of the vegetative cutting industry (and other industries in which the inventories are time-period sensitive or have a short shelf life), there are no software products that satisfy the unique needs and requirements of the business. Moreover, the inventories need to be produced over time so that they are available over the appropriate time periods. Furthermore, the production process is often subject to environmental or other conditions which can seriously affect the production process making it highly variable from one time period to another and from one production cycle to another. Therefore, there is a need for custom program software to fit the needs and logic of the business—off the shelf software was not readily available and what was available would require a lot of re-programming to be even somewhat useful. Without suitable custom software with unique features to handle inventories of such time period sensitive products, reliability as a supplier would be severely impacted and wastage and other inefficiencies in the inventory management and sales/distribution would occur.

### SUMMARY OF THE INVENTION

Some of the important features of the present invention include a computer implemented method of tracking inventories of time period sensitive items on a time period basis using independent and separate data tracking for the inventories of each of the time periods. In one aspect of the invention, the present invention provides for each time period being one week and independent and separate data tracking is done using 52 separate and independent data files, respectively, for 52 successive one week time periods that together constitute one time interval for tracking of inventories. The time interval contemplates rolling time periods so that as a first time period at the beginning of the time interval elapses, a new time period is added at the end of time interval.

One aspect of the present invention provides that the inventory is established in a farm system while the demand against this inventory is established in a sales system. The allocation of the inventories to the demand occurs in a main system which communicates with both the sales system and the farm system to adjust the demand in the sales system and the inventory in the farm system.

In one aspect of the present invention, the time period sensitive inventory item includes vegetative cuttings or plug seedlings. In one aspect of the present invention, the inventory of the individual forms that require 1 or more weeks of production are handled by a sales system component at a rooting station after the unrooted cuttings have been shipped by a production (or farm) location.

In one aspect of the invention, a sales forecast is used by the farms to establish their production plans in a farm system. The production plans correlate actual physical locations in farms to variety, type, quantity, and time periods of yield of plants. In one aspect of the invention, a security factor (or percentage) can be built in so that the expected yield is buffered from variations within the range of the security factor.

Another feature of the invention provides a variety of tools to accurately estimate and adjust the inventory on a time period basis after the production plan is created. Some of these tools include verifying actual plantings against planned plantings to adjust the time period based inventories. Another tool includes using indexes (yield per stock plant per week) such that different scenarios can be used by varying the indexes by time periods for particular plants (or even by particular variety and location for particular plants). One aspect of the present invention provides for the display of the indexes over different time periods and for the adjustment of the indexes based on data from actual inspection of the growing facilities.

Another aspect of the present invention is the automated spreading of orders from a main system to farms using logic based rules.

In another aspect of the invention, the farms assign orders to cut lists that facilitate both cutting and shipping of the vegetative cuttings.

In one aspect of the invention, the sales, main, and farm system provide information to users at a highest level of abstraction (least amount of necessary detail) with levels of additional details accessible on an as needed basis.

In one further aspect of the invention, claims processing and credit memos for spoilt or undelivered products is integrated into the inventory and sales management system of the present invention.

One further aspect of the present invention is providing a system of reservations by which one of multiple sales locations (or companies) can make reservations against expected production to accurately supply their customers while freeing the reservations in time so that unused portions of the reservation are also available for sale by the other sales locations (or companies).

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is overall system diagram showing exemplary system components of one preferred embodiment of the present invention.

FIG. 2 displays the production planning screen on the Farm system.

FIG. 3 illustrates a screen that provides for an adjustment of inventories based on plan versus actual comparisons.

FIG. 4 is a screen illustrating different index scenarios.

FIG. 5 is a screen illustrating different indexes by varieties.

FIG. 6 illustrates a calculation screen that shows by week (both graphically and in a spread sheet in the preferred embodiment) the index expected by variety by location in the farm.

FIG. 7 is a screen illustrating the assignment of cut list numbers to orders in a farm.

FIG. 8 is a screen illustrating the assignment of various cut lists to various locations within a farm.

FIG. 9 is a screen illustrating adjusting cut lists over more than one day.

FIG. 10 is a screen illustrating assigning shipping information based on various destinations.

FIG. 11 is a screen illustrating a grower verification tool.

FIG. 12 illustrates an order fulfillment screen of the Sales system.

FIGS. 13-16 illustrate how the demand can be reduced by changing orders.

FIG. 17 is a screen illustrating a production screen of the sales system according to the present invention.

FIG. 18 is a screen where a complaint/claim is entered.

FIG. 19 is a screen displayed orders with claim indications.

FIGS. 20 and 21 are screens illustrating processing of claims according to the present invention.

FIG. 22 illustrates a credit memo associated with a customer record according to the present invention.

FIG. 23 illustrates a generated credit memo according to the present invention.

FIG. 24 is a Order Fulfillment screen of the Main System of the present invention.

FIG. 25 illustrates an order detail screen for adjusting the spreading of orders to farms.

FIG. 26 is a farm distribution screen showing the total production for each variety for each ship week.

FIG. 27 illustrates a sales and booking report.

FIGS. 28 and 29 illustrate availabilities of unrooted and rooted cuttings, respectively.

FIG. 30 is a block diagram showing the components of a general purpose computer system connected to an electronic network that may be used to implement the methods and systems of the present invention.

FIGS. 31-81 are screen diagrams that illustrate various aspects of inventory management of plug seedlings according to the present invention.

### DESCRIPTION OF THE PREFERRED EMBODIMENT(S)

One preferred embodiment of the present invention, also referred herein as the Inventory Management System (“IMS”) was designed for a specific market niche, producers of vegetative ornamental horticultural products (including both rooted and unrooted cuttings) and plug seedlings. The “IMS” system, in its preferred embodiment, consists of four modules: the Sales Module, the Rooting Station Module, the Farm Module, and the Main Module. Similar logic for handling the inventories of the unrooted cuttings drives all four systems.

One of skill in the art would recognize that while the present invention is divided into four modules, the functionalities of the four modules can be combined and/or separated into fewer or more than the four modules discussed herein in the preferred embodiment. One skilled in the art would also recognize that while the preferred embodiment illustrates the inventory and sales management of vegetative cuttings, the features of the present invention could also be used with other types of inventories that are time period sensitive. For example, inventories of perishable items or goods that are produced seasonally (or generally, goods that are produced or sold during specific time periods or during particular time periods based on certain conditions) can also be managed using the methods and systems of the present invention discussed further herein.

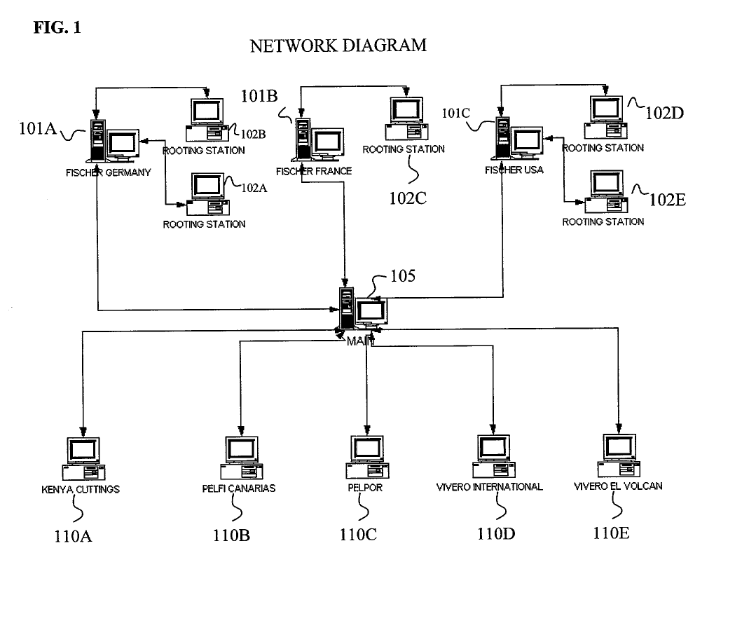

With reference to the figures, FIG. 1 is overall system diagram showing three exemplary “Selling” company systems 101A-C (Germany, France, and USA) each having one or more rooting stations 102A-E, a “Main” system 105, and five exemplary “farm” systems 110A-E. All information between the sales companies 101A-C and the farms 110A-E transfers through the “Main” system 105. In the preferred embodiment, there is no transfer of information directly between the Selling Companies 110A-C and the Farms 110A-C. Information between the sales companies 101A-C and the rooting stations 102A-E preferably transfers directly between them.

Some examples of the communications between the different system components illustrated in FIG. 1 are as follows:

Sales to Main—(I) Allocations: this is the sales companies initial request for availability and constitutes their sales forecast which will be held as a reservation in the sales company's Order Fulfillment data base. (II) Order Details and Bulk Orders: Bulk orders go against reservation and free cuttings and when only bulk orders are sent for a range of weeks the reservation for a sales company is not released by the “Main” system. When Order Details are sent for a range of weeks the reservations for the Sales company for that range of weeks is released and the “Main” only sends back availabilities to cover the requirements for the actual orders sold. When this happens the Sales company must place orders “Pending” against the “Free” cuttings available in the system and confirm the next day (for example), when “Main” sends back additional availability to cover these new orders. Late Orders may also be communicated by the Sales to Main (as discussed further herein).

Main to Sales—Availabilities and current inventory based on priorities of the individual selling company, Shipping information, order listing (what farms are sending what cuttings to what customers).

Farms to Main—Availabilities and current inventory in bulk, shipping information (day to ship, airline, air bill numbers, day of arrival)

Main to Farms—Bulk Orders and Order Details, Late Orders.

Sales to Rooting Station(s)—Order details, cutting requirements, shipping information

Rooting Station(s) to Sales—Verifications (Number of cuttings stuck, Number of cuttings shippable, Overages).

One of the requirements addressed by the present invention is the accurate reporting of the inventory of specific varieties of plant cultivars in 52 independent and separate data sets (one separate inventory data set for each week of the year). The present invention then provides for recording the sales of multiple forms of each plant variety to the specific week of inventory of the un-rooted cutting it needs to come from. Each form requires from 0 to 7 or more weeks of production before it is shipped to the customer. Zero production time is the actual un-rooted cutting that is cut off the stock plant and shipped directly to the customer or to the production location for rooting. Examples of forms and production times are:

| URC | (un-rooted cuffing) | 0 weeks |
|---|---|---|
| RC | (rooted cutting) | 4 weeks |
| JIF | (rooted Jiffy) | 4 weeks |
| CC | (callused cutting) | 2 weeks |
| QS | (quick step) | 3 weeks |
| 105 | (10.5 cm pot) | 7 weeks |

One skilled in the art would recognize that a 52 one week inventories is one example of time period based inventories according to the present invention. Other time periods, such as monthly, hourly, bi-weekly, or even seasons, could also be used with the features of the present invention. Furthermore, the present invention provides for the time-period based inventories of items (and their sales and orders) be tracked as separate data sets (or files) for particular time periods. One skilled in the database art would recognize that the data needs to be logically separated per time period while physically the data could be stored in one database or in a distributed database that is managed to provide the information and features described herein.

Some of the additional problems addressed by the present invention include:

The production time of a particular form can differ between varieties within the same cultivar. With the form “RC” the normal production time is 4 weeks however the time for some varieties can be 3 weeks and for others 5 weeks. This requires that for all to be shipped as a rooted cutting on the same week but they would need to be stuck in production on three different weeks coming from 3 different weekly inventory data files.

Forms requiring 1 or more weeks of production have production losses that require the inventory to be buffered. If there are 1,000 un-rooted cuttings available in ship week 01/01 (i.e., the first week in the year 2001, for e.g.) for a variety and for this variety there is a 10% buffer for loss in production of a rooted cutting (form RC) there would be an availability of 900 cuttings only in ship week 05/01 (4 weeks production time).

Because the inventory is a living plant the inventory needs constant verification over the different time periods that the yields are as expected, for example, on a week by week basis.

The methodology of how the present invention handles inventory is tied to all aspects of the systems (Sales, Rooting Stations, Farms, and Main). This includes, but is not limited to the following aspects of the products inventoried: Pricing, Shipping, Quotes, Production Orders, Boxing, and Freight.

In the preferred embodiment, the inventory is established in the “Production Planning Screen” of the “Farm System”. The demand against this inventory is established in the “Order Fulfillment Screen” of the “Sales System”. The allocation of the inventories to the demand happens at the “Main System” in the “Order Fulfillment Screen”. The inventory of the individual forms requiring 1 or more weeks of production at a rooting station, is handled after the un-rooted cuttings ship to the production location (i.e., rooting station) by the “Production Screen” in the “Sales System” that is linked to the “Production Screen” in the rooting station system.

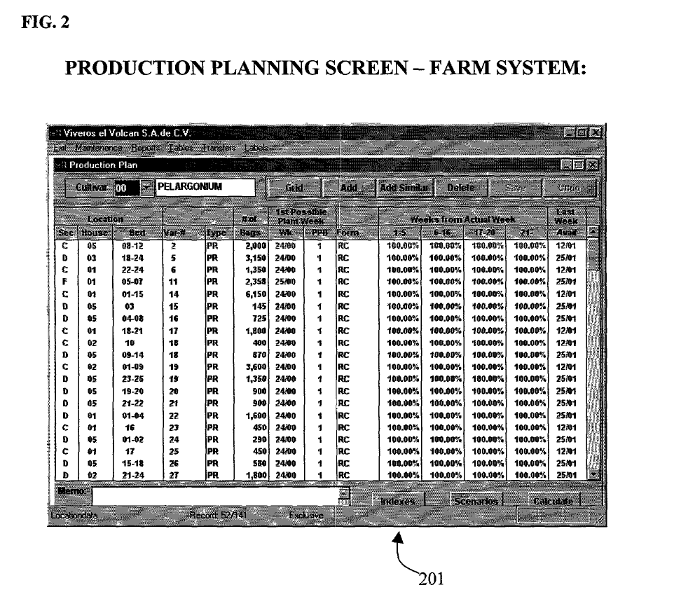

FIG. 2 displays the production planning screen 201 on the Farm system. As shown in FIG. 2, based on the initial sales forecast of the sales company(s), the farm(s) establish their production plan(s). In the preferred embodiment, the plan is developed by actual physical location (section, house, bed), by variety number, by type of production (production or elite), by number of bags(stock plants), first possible plant week (this is used for planning in the farm it does not drive availability), the index of the variety, plants per bag (this establishes how many elite cuttings are needed), and the form of the cutting to be used in planting.

One of the features of the present invention provides that security can be built in by altering the percentages in the “Weeks from Actual Week” columns shown in FIG. 2. As an example if in the column for weeks 6-16, 80% was entered—then only 80% of the calculated yield would be given to the sales company. This is security that is used until the plantation is growing well enough to project 100% availability. The last week column is when the planting will be thrown out and there is no more availability transferred to the “Main” after this week.

Another aspect of the present invention provides the logic of successful management of a vegetative mother stock farm. Many variables come to play when first estimating from the production plan the eventual yield of cuttings to the actual when the plants are actually planted, as to how they are growing, and as to how heavy they have been harvested. The present invention provides for the use of a complex set of scenarios, indexes, safety factors, cut lists, and verifications to ensure the most accurate reporting of inventories from the farms. The following figures and their descriptions in the text illustrate some of these features that result in the accurate reporting and management of the time period based inventory provided by the present invention.

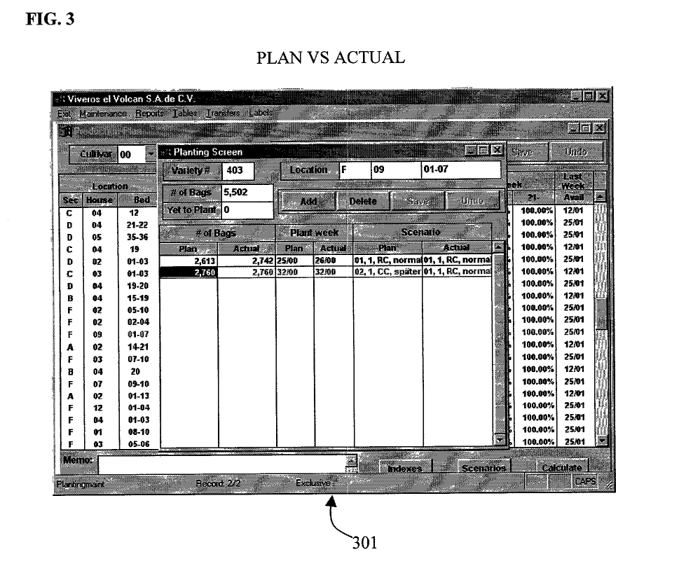

FIG. 3 illustrates a screen 301 that provides for an adjustment of inventories based on plan versus actual comparisons. For example, the plan was to plant 5,502 stock plants of variety #403 during the 25^{th} week of 2000—this was driving availability as soon as the plan was entered. Actual—2,742 were planted week 26/00 (Week Number/Year format) and 2,760 were planted week 32/00. Once actual is entered the calculation for availability is made on the actual plant dates. In this case more than ½ of the stock was planted 7 weeks later than the plan—this has a dramatic impact on availability in the early weeks (you can only begin harvesting cuttings from the stock plants after a few weeks have passed after planting and they have grown to a sufficient size). If 2 weeks pass beyond the plan date and no figures are entered for the actual—availability goes away for this variety and that plantation on the “Order Fulfillment” screen and appropriate fields are highlighted (for example, by being turned to red) alerting the user that there is an error or missing data.

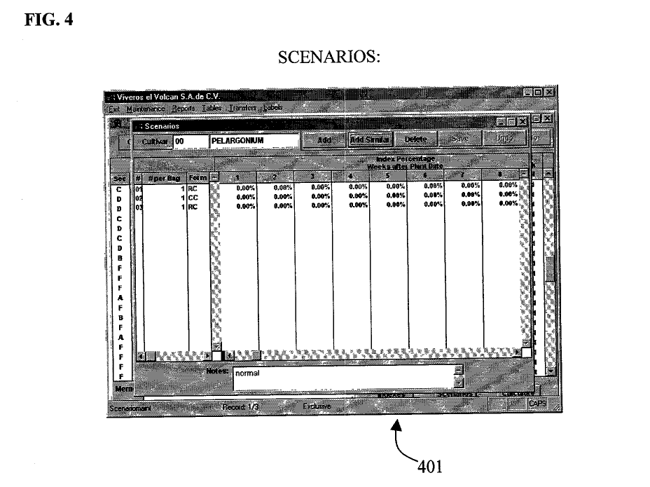

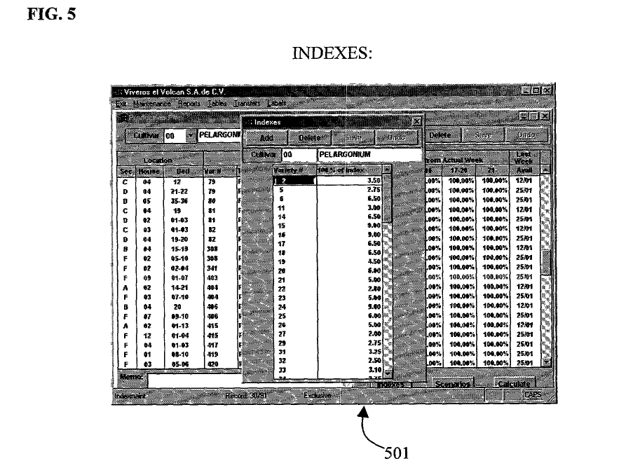

Availability is calculated by yield per stock plant per week (the “Index”) multiplied by the number of stock plants (“Bags”)—relative to the overall age of the stock plant and the type and number of cuttings used when planted. As shown in FIG. 4, the present invention provides several scenarios 401 that calculate against the “Index” (yield per week for each type and variety within the plant cultivar group). As an example one scenario might be: 10 weeks after planting make 50% of the index available, 11 weeks 60%, 12 weeks 80%, 13 weeks 100% of the final index of that variety. Scenarios can be created for each variety to fit the specific plant growth of that variety as shown, for example, in screen 501 in FIG. 5. Indexes can be different between farms or even between different plantation locations within a farm. An index is the number of cuttings expected to be yielded per plant per week when the plants are fully established. The present invention provides that the actual index information collected over time can be used as statistical data to develop the indexes used in the future. Such future indexes may be developed and correlated based on a variety of factors, for example, the particular cultivar, form of the cutting, time period, start time for time interval encompassing the tracked time periods, farm, and location within a farm.

FIG. 6 shows a calculation screen 601 that shows by week (both graphically and in a spread sheet in the preferred embodiment) the index expected by variety by location in the farm (there can be multiple locations of the same variety in the same farm). This is where verification of the projected inventory (calculated by the scenario, the index and the security factor of what % to make available relative to the number of weeks from shipping) can be modified. In the example above with variety #756 the normal index is 2.10. If after actually inspecting the crop it is decided that the yield will be higher for week 06/01, the index is increased to 2.40 (entries made by hand are displayed in red or highlighted in other equivalent way). With the two plantations of variety #756 the increase in the index of 0.30 (from 2.10 to 2.40) gives a total increase in availability of 874 cuttings ((1,332×0.30)+(1,584×0.30)) =874.

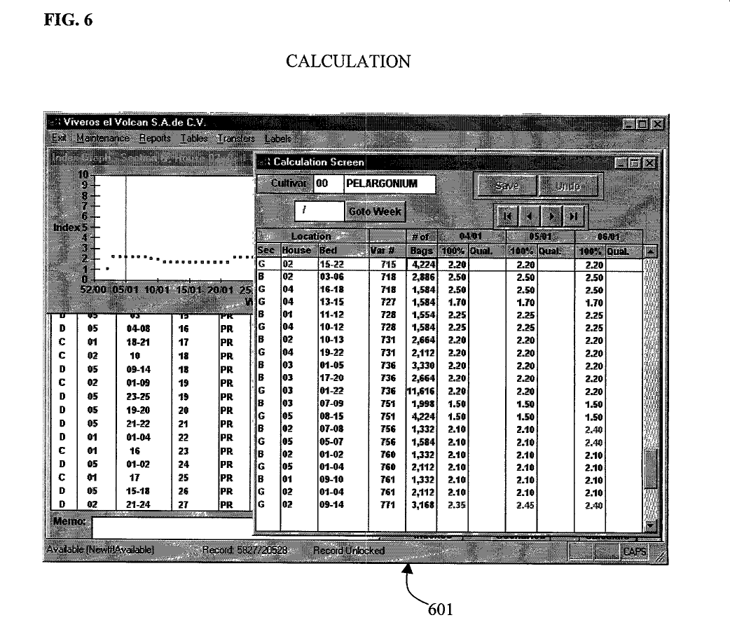

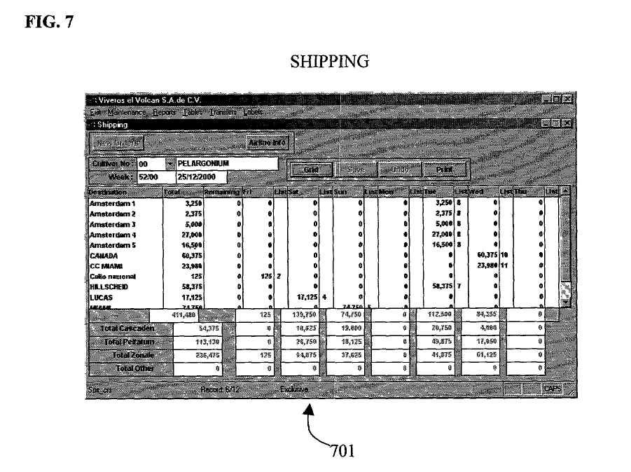

After the orders are spread by the “Main System” to the farms the orders are downloaded and grouped based on airport of destination and by production location (the number of cuttings are displayed by destination in the total column only). The farm then spreads these order to the days they want to ship and assigns a “Cut List” number to it as shown in the exemplary screen 701 shown in FIG. 7. When this is done: all shipping labels, pack lists, box counts, airline information, stick labels, and other reports are created to support the cutting and shipping for the next week.

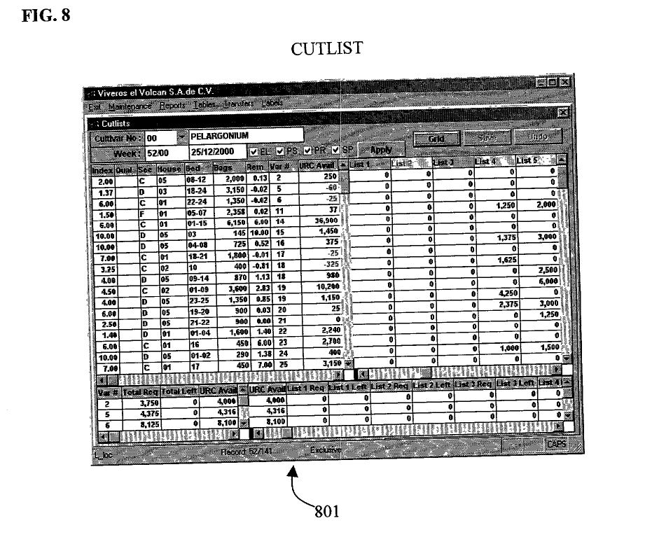

FIG. 8 illustrates a screen 801 showing the step of assigning the various cut list to various locations within the farm for cutting. This is very important for the planning for the ship week for the farm. It shows exactly how many cuttings are available in each location for each plantation within the farm. For example, farms can be over 50 acres in size and have several plantations in different locations for the same variety. As quantities are assigned to a cut list for a location the remaining cuttings in that location are calculated and shown in the column “RC Avail.” The system allows the user to over harvest a location to the level they are comfortable with (these are living plants and the availability is calculated to the best of experience—however the actual numbers of cuttings is not definite and some extra cuttings are always available if the culture is growing well). This provides various reports for managing the harvest in the farm and documentation to go along with the cuttings as to the actual location where they were cut, when they are to be cut, the customer they are to be cut for, the consolidated shipment they are to be packed for, and who was the cutter.

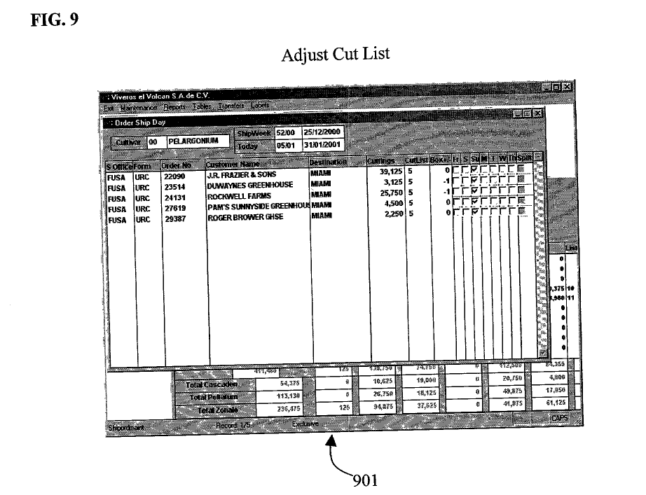

Some cut lists are too big to be cut on one day—by double clicking on the destination, brings up the screen 901 shown in FIG. 9 where they can spread some of the orders to other days so all of the cuttings are ready to ship on Sunday (for example) so that all shipments can be done on one day of the week.

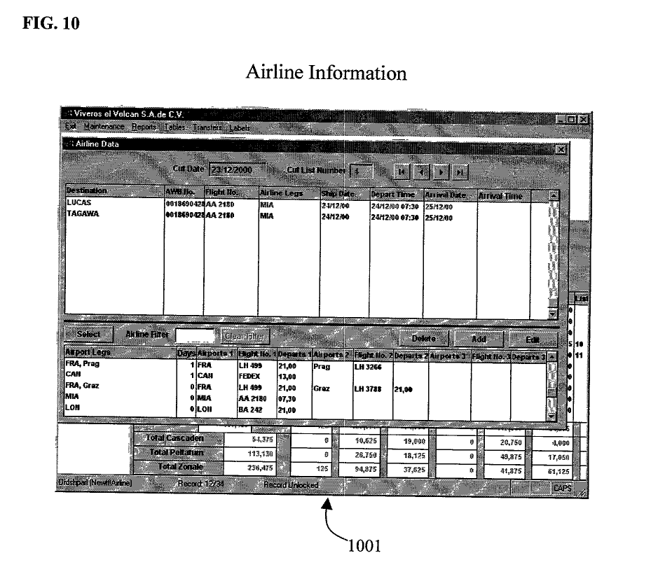

FIG. 10 illustrates a screen 1001 that shows that shipping information, such as, airline data and Airway Bill (AWB) Numbers, departure dates and times, arrival dates and times are assigned to the various destinations. This information is also uploaded to the sales offices via the “Main,” is useful in optimizing flight or route planning.

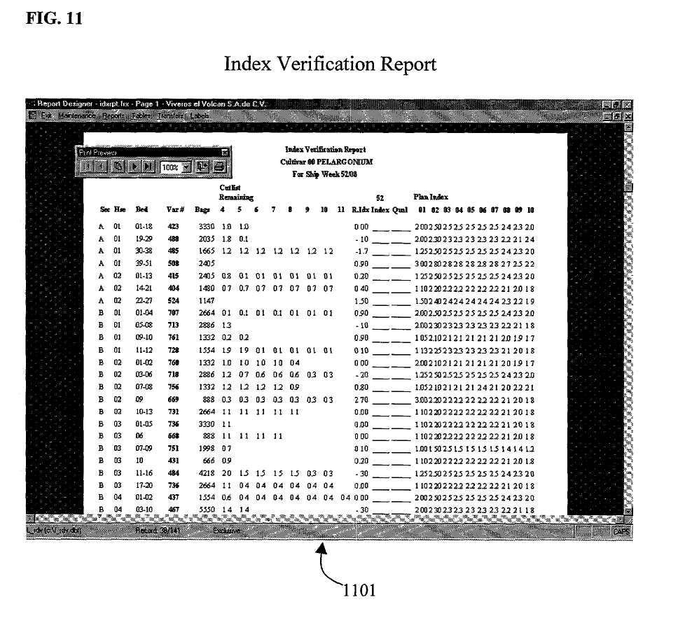

FIG. 11 illustrates a screen 1101 of a tool for the growers, an “Index Verification Report” where the actual status of the plants can be verified while the actual harvesting is going on. On the report shown in FIG. 11, there are 8 cut lists still to be cut for the present ship week 52/00 (4-11). The report shows the variety number and location in the farm. If the grower is verifying the index for the next ship week (he walks the farm and inspects the plants at each location to do this) and he is at the variety third from the top (Sec.-A, House-01, Bed-30 through 38, variety-485)—there are still 7 different cut list to come from this plantation. The remaining index is a negative −1.7. The report shows a planned index for ship week 01/01 of 2.0. If he sees an average of 3 cuttings on the plants the grower will have to reduce the index for the next ship week to 1.3 (cuttings available on the plants+the remaining index) or (3+(−1.7))=1.3. He can also look at the general health of the plants and project the index out for several weeks.

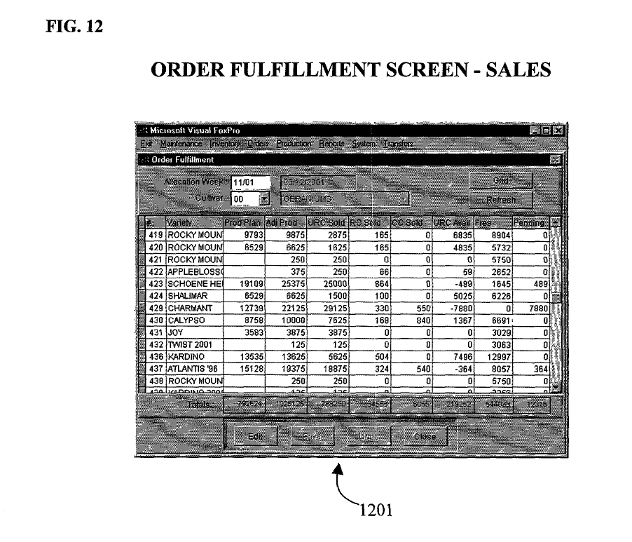

FIG. 12 illustrates the “order fulfillment” screen 1201 of the Sales system that shows the state of the inventory for the sales company(s) based on the distribution of availability against orders. In the preferred embodiment, each sales company has its own specific “Order Fulfillment” screen. The example in FIG. 12 shows the initial sales forecast for week 11/01 of total un-rooted cuttings required in the “Prod Plan” column, the cuttings that have been allocated to the sales office(s) from the farms by the “Main System” to satisfy orders or the sales forecast (which ever is greater) in the “Adj. Prod.” Column. The total un-rooted cuttings (URC) sold to ship week 11/01, the total rooted cuttings (RC) sold plus buffer to ship week 15/01 (4 weeks production time), the total callused cuttings (CC) sold plus buffer to ship week 13/01 (2 weeks production time), the remaining URC availability (balance of the unsold reservation) in the “URC Avail.” column, free cuttings that have not been reserved or sold that are available from the farms in the “FREE” column, and pending quantities that have been sold against free numbers that have not yet been allocated by the “Main System” back to the selling company in the “Pending” column.

With variety #419, 9,875 cuttings have been allocated to satisfy the sales forecast of 9,793. 2,875 URC and 165 RC (150 plus buffer of 15) have also been sold. This leaves 6,835 left in the reservation (these quantities can be confirmed immediately to the customers since they are coming from the sales company's own private reservation). There are 8,904 free cuttings left at the farms that no selling company has reserved or sold. The total that can be possibly sold is “Available +Free”—15,739 cuttings.

With variety #423, 25,375 cuttings have been allocated—this is 6,266 more than the original sales forecast. 25,000 URC and 864 RC (includes buffer) have been sold. Available is—489—this is because the reservation has been sold and current selling is against the “Free” numbers of 1,645. This leaves a pending amount of—489. When downloaded to “Main” and if the cuttings are still there, we will get back new “ADJ PROD numbers of 25,875 (multiples of 125) leaving Available 11, Free 1,145, and Pending 0. If more than one sales office goes after the same free cuttings the “Main” will pro-rate back to the sales offices based on their total quantity sold of that variety.

With variety #429 we have available—7,880, Free 0, and Pending—7,880. Since there are no Free numbers we are oversold by 7,880 cuttings. In general, the Sales system does not allow us to over sell at order entry time—if there is no availability the order can not be placed. However, this shortage may have happened due to a reduction in availability from the farms after the order was placed and the required inventory was confirmed by the “Main” back to the sales office. When the farms reported a reduction—this shortage was pro-rated back to the sales office(s) by the “Main”. Therefore, there is a need to reduce demand by changing orders.

FIGS. 13-16 illustrate how the demand can be reduced by changing orders. The system provided by the present invention is designed to be user friendly. The “Order Fulfillment” screen shows bulk availabilities and bulk demand and when there is a problem we need to find the details. When there is a problem with variety #429, the present invention provides that we can “Drill Down” to the line item detail to make adjustments to the orders. FIG. 13 illustrates a screen 1301 that shows all of the orders for #429 for ship week 11/01. Displayed on this screen is the order number, the form, the Broker, the Customer, and the total ordered for the specific variety in question.

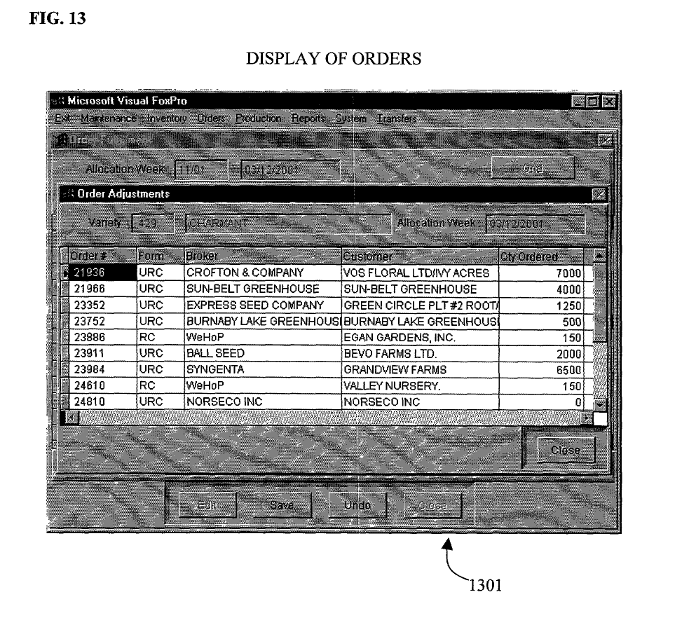

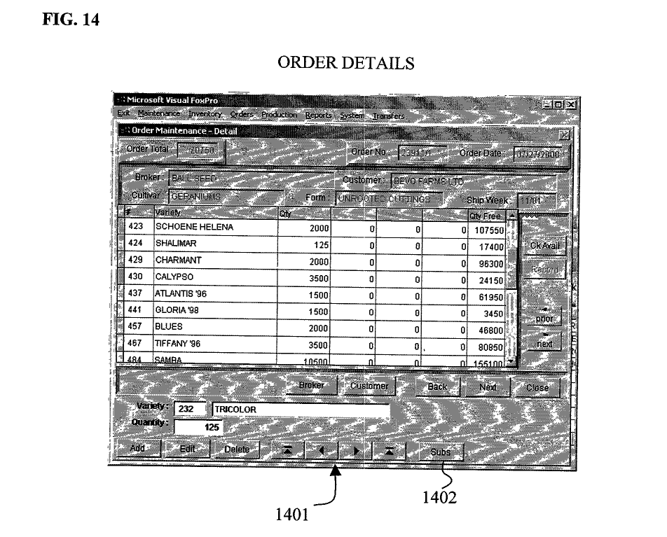

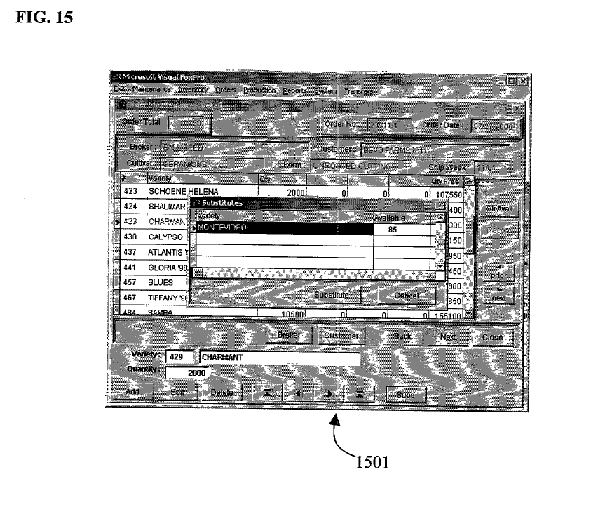

If we select order #23911 for BEVO FARMS, we can see the line items for that order as shown in screen 1401 in FIG. 14. Thereafter, the present invention provides that we can go to the line item for #429 and delete or decrease the quantity ordered to reduce the impact of our being over sold. Another option would be to automatically sub (using the “SUB” button 1402) a like or similar variety. In this case there are only 85 cuttings available of the recommended sub (as shown, for example, in the screen 1501 of FIG. 15).

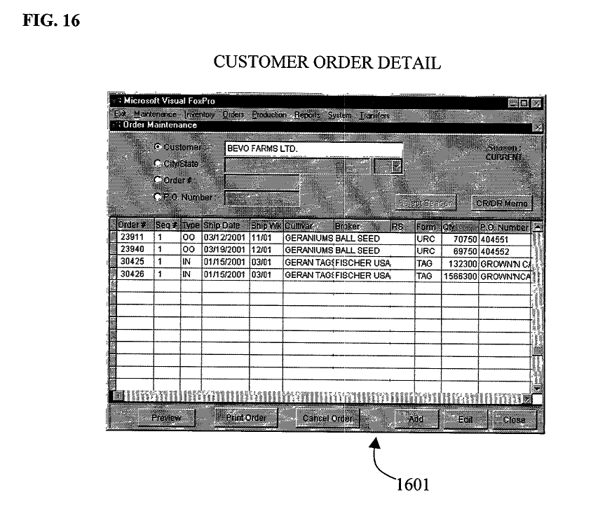

After saving these changes, the present invention provides that we are brought automatically to the “Customer Order Detail” (as shown screen 1601 in FIG. 16) for Bevo Farms where we can place a new order in another week to make up for the shortage. In this case the customer already has an order for shipping week 12/01. We can add the shortage to his next order from this screen.

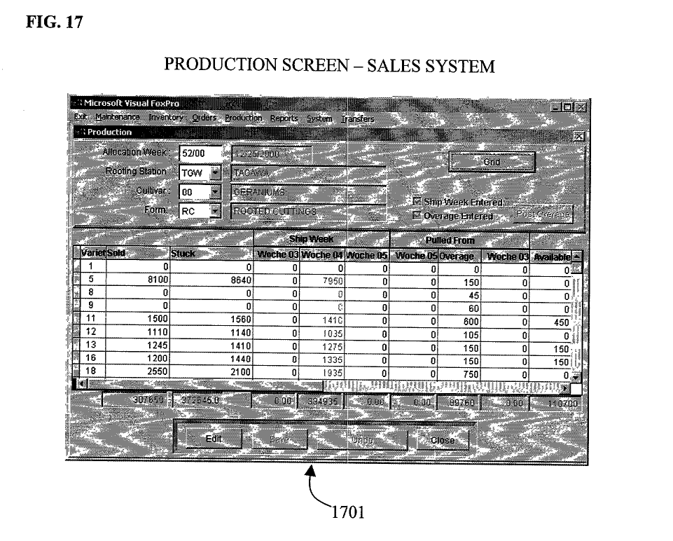

FIG. 17 illustrates a production screen 1701 of the Sales system. After the un-rooted cuttings have shipped for the ship week all tracking of the un-rooted inventory stops for that ship week and the system locks out the possibility to change orders in the “Order Fulfillment” screen after the cut off date. However, cuttings that have been sold in a form that still requires production time still need to have certain controls for validating inventory. This is done in the production screen 1701 shown in FIG. 17 with a series of verifications. The production screen shows the total amount sold (updated as to the current status of the orders).

The first verification is the “Stuck”—here the production location (for example, a rooting station) enters the total number of cuttings stuck by variety. The quantities displayed in the “Sold” column include the buffers. This is uploaded to the selling company via the web or other equivalent public or private network. Any shortages need to be addressed by the selling company. When orders are changed a new download of the order quantities is sent from sales to the rooting station.

The next is “Ship Week”—here the production location enters (10 days prior to the ship week) the total number of shippable cuttings by variety. After the cut off date (10 days prior to the ship date, for example) the quantities displayed in the “Sold” column reflect only the total quantity ordered (buffers no longer are included). This production verification is uploaded to the selling company via the web or other equivalent public or private network. Any shortages need to be addressed by the selling company. When orders are changed a new download of the order quantities is sent from sales to the rooting station.

The last is “Overage”—here the production location enters an accurate accounting of numbers by variety of shippable cuttings left from the week prior. This is uploaded to the selling company via the web or other public or private network. Any shortages need to be addressed by the selling company—any overages can be sold.

In the “Ship Week” the production location can also pull product one week early or push off one week later quantities to ship. This is uploaded to the selling company via the web or other equivalent private or public network. Any shortages need to be addressed by the selling company.

The user (at the sales location only) can drill down to the line item detail the same as in “Order Fulfillment—Sales”. In the preferred embodiment, the rooting station can not drill down to the order detail or change any orders—their responsibility is to verify and report the inventory of the cuttings being rooted.

Another unique feature of the present invention is a “claims/Credit Memo.” For example, the Sales System provides for the “claims/Credit Memo”. Many times when there is a problem with a perishable products a customer may report that there are possibility of losses that may need to be confirmed. As soon as notified by the customer, the present invention provides for entering a claim and the circumstance or details of the problem (quality, shortage, freight problem) and this is saved on the system as a “Claim”. The customer will usually call back and provide an accounting of the losses incurred.

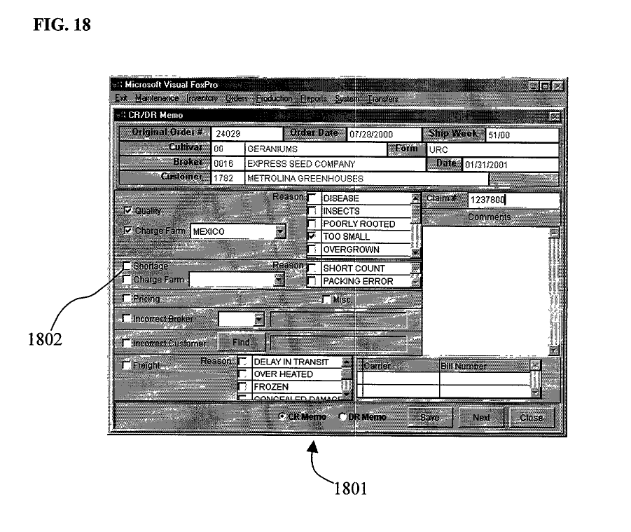

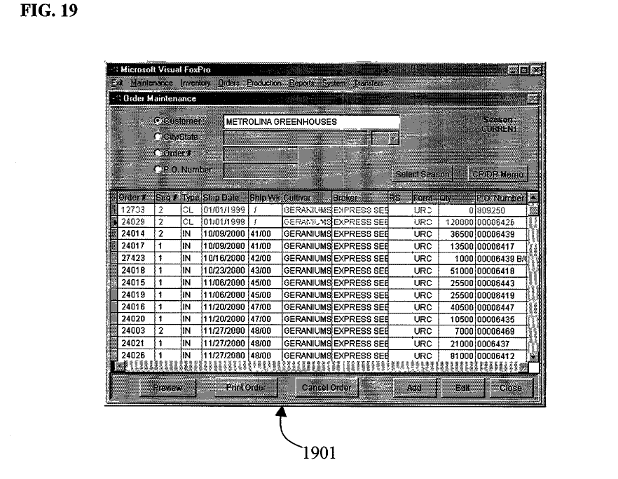

FIG. 18 shows a screen 1801 where such a complaint/claim is entered. Saving the entries and going no further enters a claim in the customer's record and is referenced by the same number of the order with the type being “CL” as shown in the screen 1901 in FIG. 19.

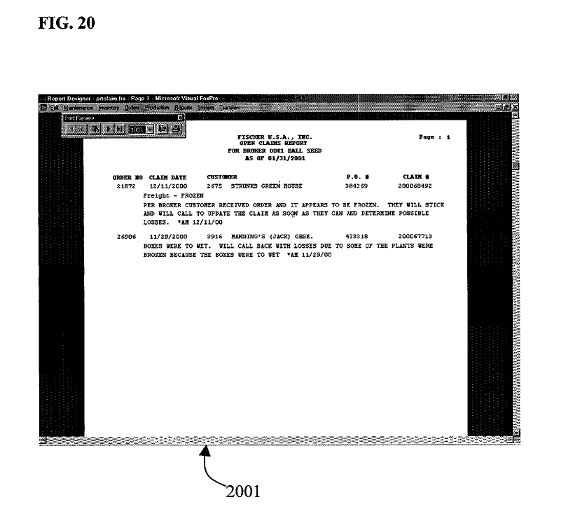

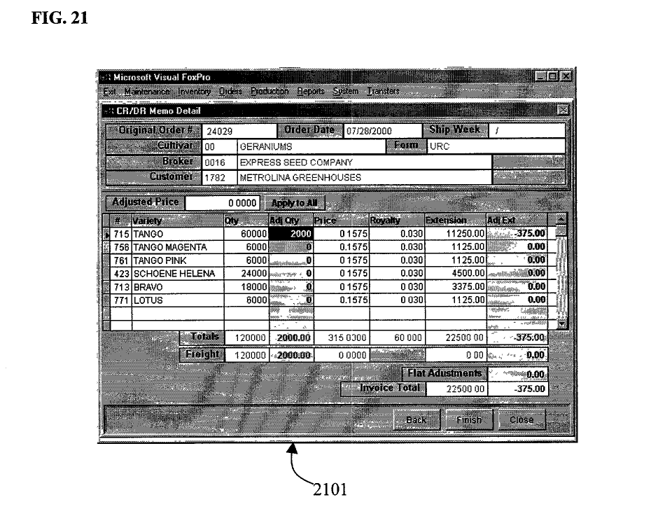

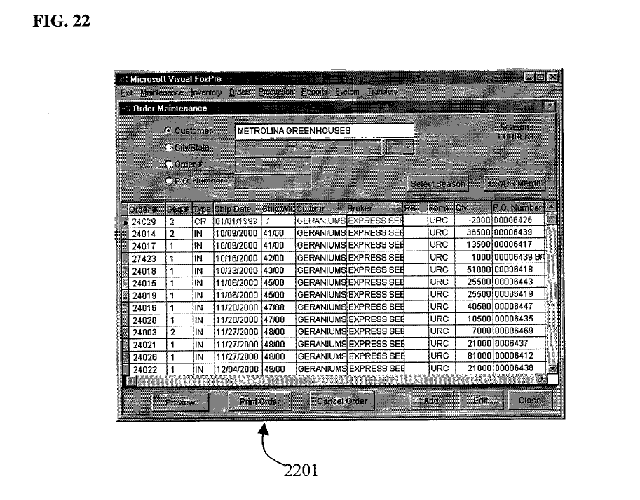

The present invention provides for tracking claims. If the customer does not call back, an open claims report is prepared as illustrated in the screen 2001 of FIG. 20. Thereafter, once the customer calls back with the number of cuttings lost, the claim can be opened and the number of cuttings lost can be entered in a “adj qty” field for the variety in question so that the amount of a credit memo can be automatically calculated as shown, for example, in screen 2101 in FIG. 21. FIG. 22 illustrates a screen 2201 that shows that the credit memo is associated with customer record.

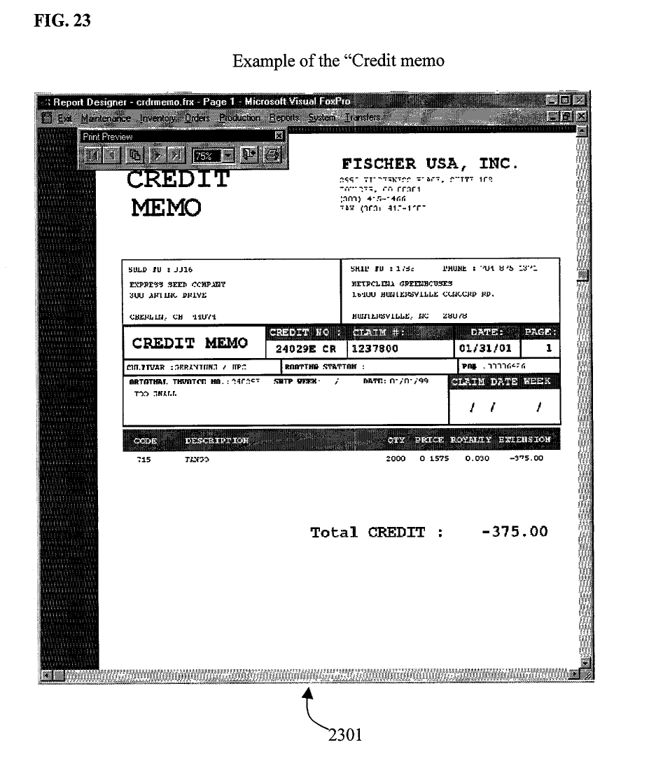

Thereafter, a credit memo 2301 (as illustrated in FIG. 23) is generated and sent to the client. In the case of the credit memo 2301 illustrated in FIG. 23 for a quality problem of 2,000 cuttings being too small, the farm that produced the cuttings is automatically charged back for the problem in one aspect of the present invention. This is done, for example, by selecting a “Charge Back the Farm” box in any of the screens in which the claim adjustment is processed and selecting the farm responsible in the pull down menu. For example, box 1802 shown in FIG. 18 may be used for this purpose.

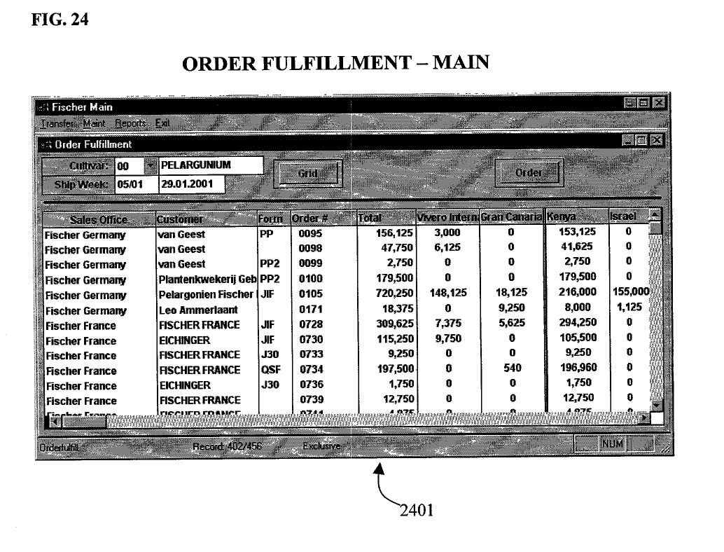

FIG. 24 shows a “Order Fulfillment” screen 2401 of the Main system that shows all orders for all of the selling companies by week for the entire season. There is a separate data base for each cultivar (00 for Geraniums, 20 for New Guinea Impatiens, 30 for Petunias, 50 for Poinsettias, and so on). Before the orders are spread to the farms the total quantity on the order is shown in the “Total” column and the farm selected is “None Selected”. On Wednesday (or any other day) prior to the ship week, the sales companies compare their orders to the most current availabilities from the farms (that has been sent to them from the “Main” system on Tuesday (or previous) evening)—correct where necessary and download back to the “Main”. All of the orders have now been corrected so that demand equals supply and are displayed on the “Main—Order Fulfillment” screen (showing sales office, customer, form, order number, and total cuttings on the order).

The orders are then spread automatically to the farms by the “Main” system for the next ship week only (as displayed in FIG. 24). This process is mostly automatic using certain rules based on logic and priorities for the selling companies. For example, rules can be based on a goal to satisfy these orders completely with the minimum amount of splitting of the individual orders between farms and to also insure that orders for Quick Steps (QS is a form that is rooted for three weeks at the actual stock plant farm) goes to the farm that is producing the Quick Step and that the inventory of cuttings is at that farm. In the order entry, at the sales office, the farm to do the QS order is decided at order entry time and is placed in the header of the order and the order is directed to that farm by the “Main” system (most farms do only URC—some farms do URC and QS so it is critical that QS orders go to the right farms and that these orders be spread first to secure the inventory of the un-rooted). The sales system also tracks capacity issues for rooting space at the farms and the rooting stations—if either is out of space for the form being entered the order cannot be placed to that location or for that form (if only being produced in one location).

Some of the exemplary logic (or rules) used in spreading the orders to the farms are:

First is the farm priorities of the sales office (set at the “Main” system). For example, USA sales company only sources cuttings and availabilities from the two Mexico farms—Germany and France source from all of the farms (Kenya, Portugal, Gran Canaries, Israel, Mexico 1, and Mexico 2). However France's first choice is Kenya and Germany's first choice is Gran Canaries.

Next, all QS orders are spread to insure cuttings are at the farm to root the product on location and ship 3 weeks later to the customer.

Next, some customers have farms of choice. This choice of farm is established in the customer record at the individual sales office and the “flag” for the farm of choice is transmitted to the “Main” with every order for the customer.

Next, start spreading from the smallest order to biggest order. This gives the best chance of filling the small and medium orders with minimal splitting between farms. If at first pass an order can not be filled completely at the first priority farm—the system tries to fill it completely at the 2^{nd} priority farm, or the 3^{rd} priority farm, and so on. If not possible, the orders goes to the farm that can fill the largest percentage and takes the balance to the next. Large orders can be split with little problem because the quantity going to the various farms is large enough to be economically shipped.

The last orders to be spread are the production orders (RC, JIF, PP, and so on) that are going to the Selling Companies rooting facilities. These are usually our largest orders and we can deal with the issues of getting cuttings from multiple locations more easily internally than can our customers for the un-rooted cutting. These production orders are a compilation of multiple orders sold by the Selling Company and are presented to the farm as a single order (these orders include the buffers required for rooting and are rounded up to the nearest 125 which is the multiple shipped by the farms plus any speculation the sales company decides to put into production—this compilation is done in the sales office and sent to the “Main”).

When the orders are spread the “Farm Selected” goes from “None Selected” to the farm of choice.

It should be noted that the above are exemplary rules for spreading the orders to the farms. One skilled in the art would recognize that other rules and/or other sequences of the rules may also be used to spread the orders to the farms.

After the automatic split, manual manipulation of the quantities can be done as an over ride to the automatic spread. Quantities can be moved from farm to farm to make logical and economical quantities being shipped for the order.

In one aspect of the present invention. all of the orders are “Production” orders that are displayed as shown in screen 2401 in FIG. 24. Order #0728 is for the form JIF to be produced at our Fischer France location. The total quantity of 309,625 cuttings is presented to the farm as one order for un-rooted cuttings shipping week 05/01. For Fischer France this is the quantity of cuttings needed to supply over 100 individual orders for Jiffy's shipping on week 09/01. The sales system automatically and continuously calculates a production order for each week, which is the sum of all orders plus buffers rounded up to the nearest 125's (for example). On Wednesday (or any other specific day) before the ship week of the un-rooted cutting the sales office can adjust this order by variety either up or down in the “Edit Production Orders” screen 2501 as shown in FIG. 25.

As shown in FIG. 25, the “Edit Production Orders” screen 2501 allows you to drill down to the detail of the orders and see displayed the remaining availabilities by farm to help in the manual selection of a different farm than what was automatically selected by the “Main” system. To change the farm of choice for variety #5 below simply select Vivero International (where there are still 13,914 cuttings available) to replace Vivero El Volcan (who is 75 cuttings over sold) in FIG. 25. After checking and correcting all of the orders, the order details are sent to the farm. The result can then be seen in the “Shipping” screen of the Farm system as discussed earlier herein.

Orders are spread, for example, on Wednesday of the week prior to shipping. This allows the farms time to do all of the necessary planning for the up-coming ship week. However many times there may be late requests (after the final orders have been sent to the farms). In one aspect, the present invention provides that the “Sales”, “Main”, and “Farm” systems are able to transfer late orders as “Late Orders” in a single file and not disrupt any of the spreading done at the “Main” or any of the spreading and allocation to cut list of the orders previously received on the scheduled download by the “Farms.”

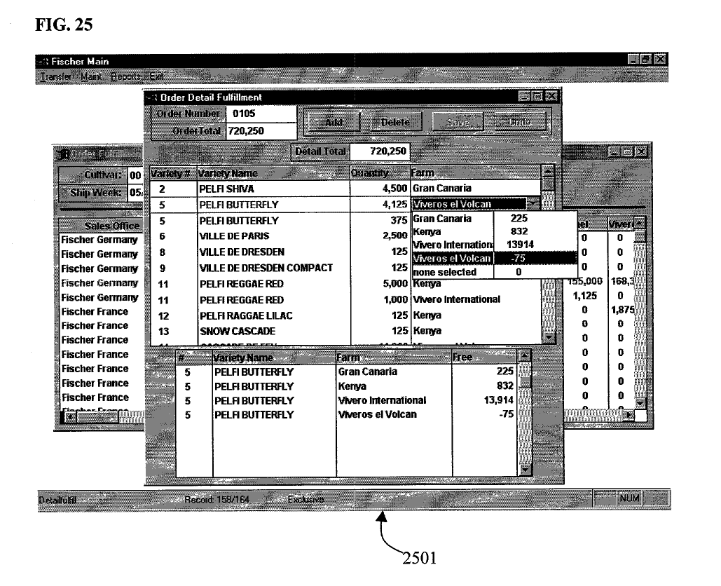

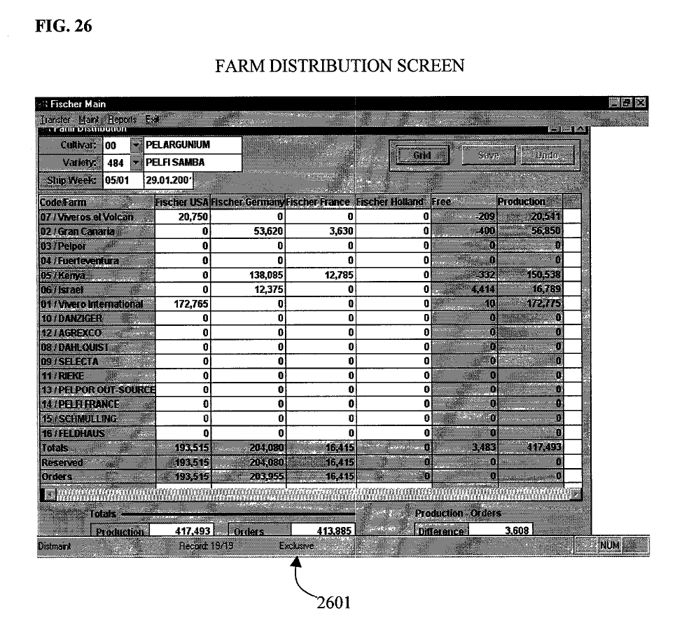

FIG. 26 is a farm distribution screen 2601 showing the total production for each variety for each ship week, the total demand for each selling company, and a summary of the total production for all farms and a similar summary for the selling companies. Additionally you can see how the production is spread from the farms to the selling companies in bulk numbers without the order details. Here it is possible to force a farm negative up to 10% (for example) of their total production to satisfy orders and with the permission of the farm(s) impacted.

It should be noted that although the “IMS” system of the present invention works for a company with only one selling location and one farm location (where the stock plants are growing—either co-located with the selling location or remotely located)—it works equally well with one selling location and multiple farm locations, and with multiple selling locations and one farm or multiple farms.

With multiple sales locations, the present invention provides a system of reservations that will allow the sales companies to supply the anticipated needs of their customers and at the same time release this reservation a specified number of weeks before the ship date so as to not tie up unused inventory needed by another. This method of reservations and free numbers tied to the transfer of “Bulk Orders” and “Order Details” is unique and special. With multiple farms the present invention provides a system of priorities of allocating which orders from which selling companies to which farms and even which orders to which farms.

The present system is user friendly and is designed to deal with the lowest level of detail (least details of information) until it is time to ship or there is a problem—then you can drill down to the highest level of detail (greatest details of information) to accomplish the task. For example, when dealing with the lowest level of detail, the present invention works with “Bulk Orders” and “Bulk Inventories”. When working with the highest level, all aspects of the individual orders and to the actual stock plant at its actual location in the farm are provided.

Communication and transfer of information is important because most vegetative companies have their selling companies in major economic markets and their stock farms located off shore (Central America, South America, Africa, Mexico) where the climate is better and the costs are lower. The system is designed to send all communications via the web or other equivalent private or public network (allocations, inventories, bulk orders, order details, late orders, and shipping information to name a few).

Some of the features of the present invention include:

Pricing by customer by volume

Boxing requirements by one variety by case or mixed varieties in one case (giving pull lists, pack lists and labels)

Freight pricing by either a flat charge for orders under a certain quantity or at a charge per unit.

Customer pick-up discounts.

Besides changing orders in the “Order Fulfillment” and “Production” screens we allow multiple changes to orders in various summary screens. These changes impact mode of shipment, location of the rooting station, freight charges and the like—not just quantity changes.

Establishing and tracking “claims” prior to the issuance of a “Credit”. All claims and credits are tied to the original order.

Shipping program that allows the product to be pulled by variety and distributed over multiple racks and shelves so that it is loaded—by customer—in order of the drops for the delivery truck. Once a truck is planned it is possible to put another drop any where within the load and everything is automatically re-calculated

Linking of the base inventory of the URC to the grower ready products (like the forms RC, JIF, PP) to the finished product (for example, 6” poinsettia.

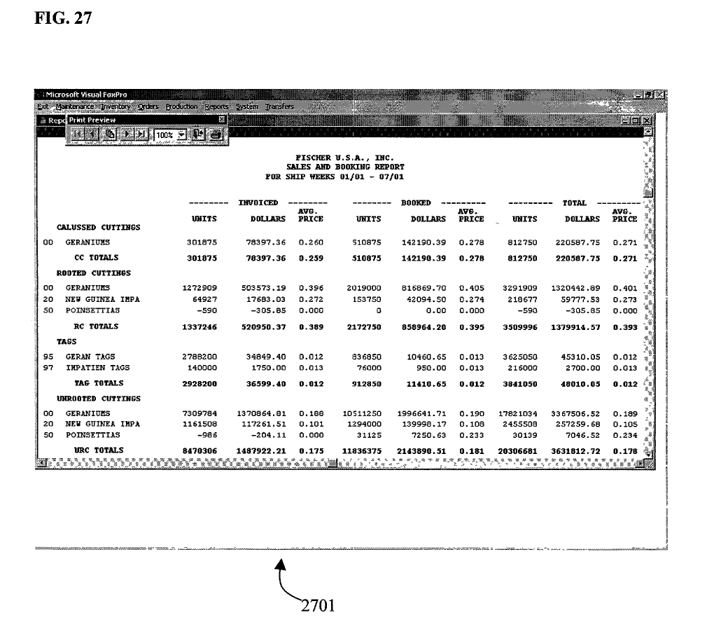

FIGS. 27-29 illustrate some of the exemplary reports that may be generated in accordance with the present invention. FIG. 27 illustrates a “sales and booking” report 2701.

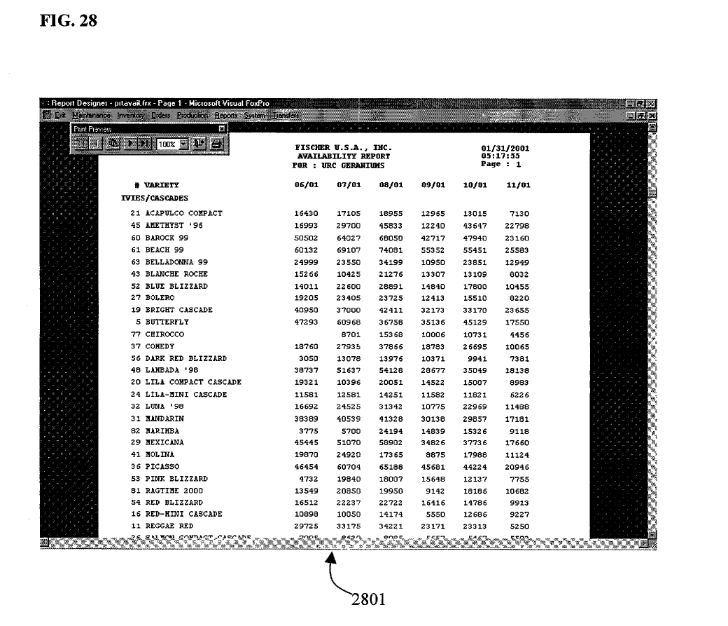

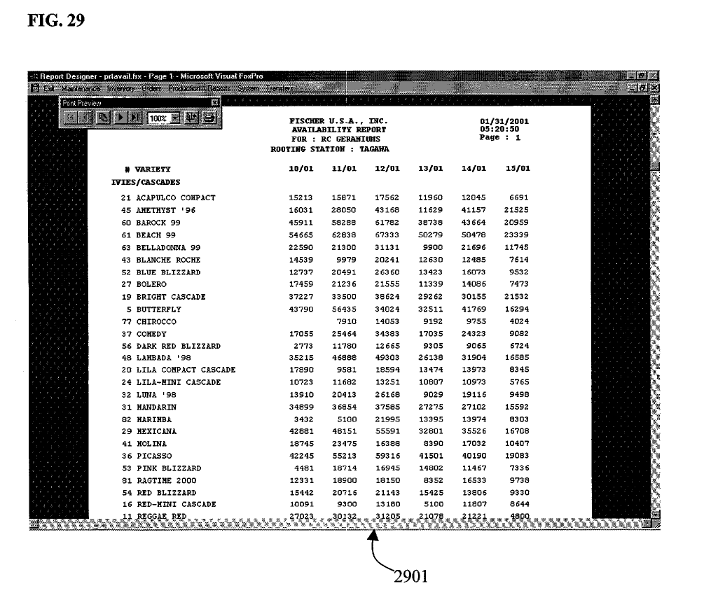

Current availabilities can be quickly printed in an availability report 2801 as shown in FIG. 28 or sent to a file. FIG. 28 illustrates un-rooted cuttings shipping from week 06/01 (the week of Feb. 5^{th}, 2001) until week 11/01 (the week of Mar. 12^{th}, 2001). To print an availability for rooted cuttings coming from the same inventory of un-rooted cuttings you would need to print an availability for the ship weeks 10/01 through 15/01 (4 weeks production time) as shown in the availability report 2901 in n FIG. 29. In FIG. 29, the quantities shown are reduced by the amount of the buffer to prevent the possibility of over selling.

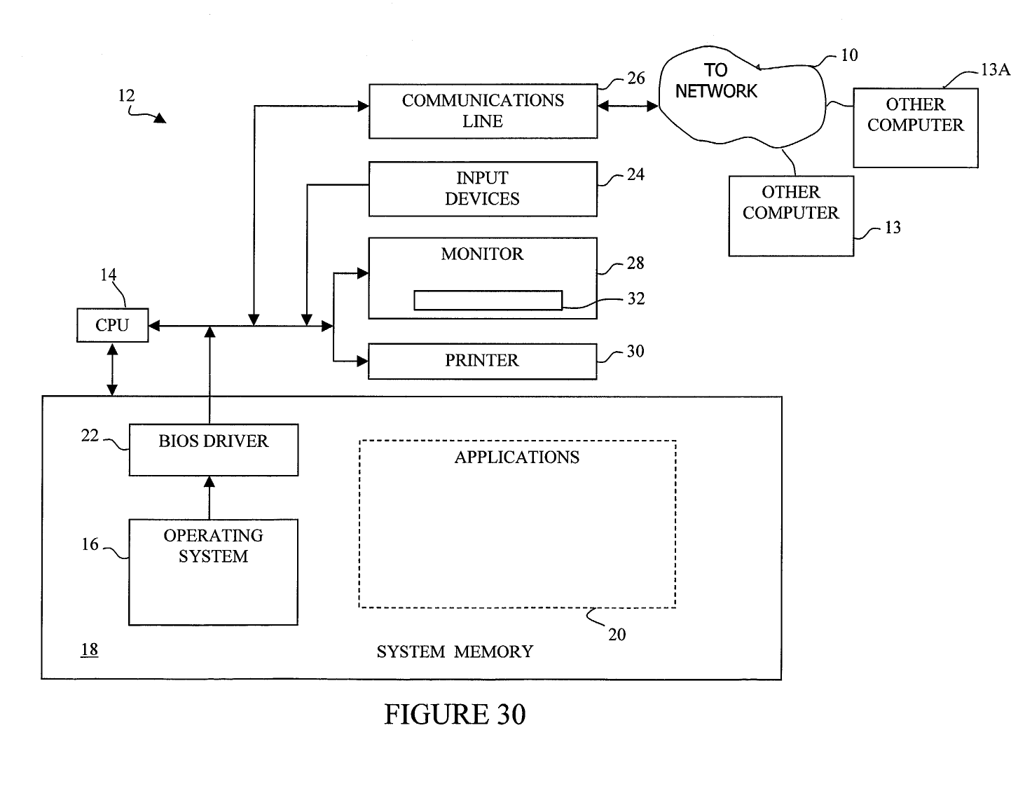

FIG. 30 is a block diagram showing the components of a general purpose computer system 12 connected to an electronic network 10, such as a computer network. The computer network 10 can also be a public network, such as the Internet or Metropolitan Area Network (MAN), or other private network, such as a corporate Local Area Network (LAN) or Wide Area Network (WAN), or a virtual private network. As shown in the FIG. 1, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse and a keyboard 32, and output devices such as a printer 30 and a display monitor 28.

The computer system generally includes a communications interface 26, such as an ethernet card, to communicate to the electronic network 10. Other computer systems 13 and 13A also connect to the electronic network 10. One of skill in the art would recognize that the above system describes the typical components of a computer system connected to an electronic network. It should be appreciated that many other similar configurations are within the abilities of one skilled in the art and all of these configurations could be used with the methods and systems of the present invention. Furthermore, it should be recognized that the computer system and network disclosed herein can be programmed and configured as computing sites (such as a Main System, Sales System, or Farm System), by one skilled in the art, to implement the functionalities discussed earlier herein.

In the preferred embodiment, a rooting station communicates with a Sales System to manage the inventories of the rooted products. Some of the high level menu functions implemented to provide the functionality of a rooting station system include the following.

1. EXIT

Simply click on the “EXIT” option to leave the program. NEVER CLICK ON THE “X” IN THE UPPER RIGHT OF THE SCREEN TO EXIT OR IN ANY OTHER PART OF THIS PROGRAM!

2. INVENTORY:

Here you have two options “RC To Ship” and “Truck Shipments”.

“RC To Ship”—This shows you how many boxes there are to ship in any given week and the mode of shipping. This is also where you will decide how many boxes and what modes you will ship on the three shipping days—Monday, Tuesday, or Wednesday. This selection creates the Delivery Notes, Pack Lists, and Labels in the “Shipping Module”.

“Truck Shipments”—This is where orders are assigned to separate trucks

3. PRODUCTION:

Here there are five options:

“Production”—This is the screen where all verifications (Stick, 10 day prior to ship, and overage) are entered. This is the primary control for inventory.

“Billing Report”—Based on the quantities verified in the Stick Verification the report quantifies how much is to be billed to Fischer USA

“Stick Report”—This is a handy report showing the quantity per variety to be stuck (orders plus buffers) and the number of strips required for the quantity (rounded up to the nearest strip). There is a lined column to the far left where the actual number of strips stuck can be recorded.

“Ten Day Report”—This report is designed to make the 10 Day Prior to Ship verification organized and easy.

“RC Report”—This report shows the state of the inventory relative to orders over a 4-week time frame and the demand for the next few weeks. This is a helpful tool in deciding whether to “Pull” or “Push Off” inventory or to “change orders” to eliminate negative numbers.

4. SHIPPING:

Here there are four options:

“Delivery Notes”—This is where you can print by delivery day and mode the orders for picking and an order listing for organizing the shipping.

“Pack Lists”—This is where you can print by delivery day and mode the “Pack Lists” to go along with the shipments.

“Labels”—This is where you can print the labels for the boxes to be shipped.

“Pull and Pack List”—This gives you a total of what to pull by variety for a ship day or ship day/mode of shipping.

5. TRANSFERS:

Here there are three options:

“Uploads”—This is the process you need to run after receiving new data from the Boulder Sales Office. THIS PROCESS MUST BE RUN EVERYTIME NEW DATA IS RECEIVED!

“Production”—This is the process that sends your latest updates to the verifications entered into the “Production” screen.

“Receive”—This is the process that pulls in the data sitting in your mailbox.

6. SYSTEM:

This is where certain parameters are set such as plants per strip/tray, multiples, and the billing percent.

In an alternate embodiment, the present invention is configured to provide two additional features. (1) Multiple production times can be provided for various rooted products. For example, some of the varieties may take only three (3) weeks to root while some of the other varieties may take eight or nine weeks to root. By allowing multiple production times for these rooted products, the time period inventory for the rooted products can be more accurately assessed in line with the actual production time for the respective rooted products. (2) A warehouse function is also provided by which after a large quantity of certain varieties are rooted they are put into a low cost cold frame where the rooted products go partly or fully dormant. Such warehoused rooted products can now be delivered over wider range of time periods and need to be allocated only to the time periods based on the production times of the rooted products. In fact, such large warehoused productions can be combined so that a large inventory of rooted products may be available at specific controlled time periods rather than having the rooted products only available at a specific time period determined by the production time for a rooted cutting. Such a warehoused inventory of rooted products can be combined with other time period based inventories as discussed earlier herein with respect to the Sales, Rooting station, Main, and Farm systems.

In another alternate embodiment, the present invention provides for tracking of inventories of plug seedlings (or plugs) typically produced from seeds. The inventories of the plug seedlings are tightly coupled to the seed inventories and include adjustment factors to account for wastage, spoilage, or other losses associated with producing plug seedlings from seeds.

The seed inventory can be made up of seeds on hand or be based on arrival dates of purchase orders placed for the seeds or a combination of both. Since the plugs are typically sold in trays of variable sizes (for example, a 72 tray or a 288 tray), the ratio of plugs to seeds varies significantly. Therefore, the inventory tracking of the plugs from seeds has to use a suitable factor to approximate the ratio of plugs to seeds in order to derive accurate inventories for plugs from a seed inventory. Statistical data based on factors such as variety, seed type, farm, location within a farm, season, etc. may be used to refine the appropriate plug to seed ratio to be used in the system. Furthermore, the availability of plugs may also be altered by allowing multiple production times for the plugs.

Another feature of the plug inventory management is the tracking between various forms of the plugs including any transformations/transplantations needed to arrive at the final plug form to be sold. For example, non-stop begonias that are sold in a 72 tray maybe first produced in a 288 tray. That is, they may be first grown in a 288 tray for 9 weeks and then transplanted into a 72 tray before being grown for another 6 weeks before they are ready to be sold. Therefore, for every 72 tray sold, the system tracks the number of 288 trays that must be sown and also provides an indication (such as a report) of the transplantation schedule. Furthermore, the actual availability can be tied to the results of the transplantation process. That is, the initial estimate of availability is based on number of 288 trays sown adjusted by a suitable adjustment factor. Of course, the number of seeds sown is also determined by a ratio of the plug to seeds for a particular plug and location. Thereafter, the availability is altered based on actual verification of the transplanting from the 288 trays to the 72 trays. The plug system is also tied to the sales system fulfillment screen.

In one implementation of the plug system, the following exemplary menu driven functionalities are provided.

The menu options are grouped under three broad headings: (I) Maintenance, (II) Inventory; and (III) Production.

Maintenance:

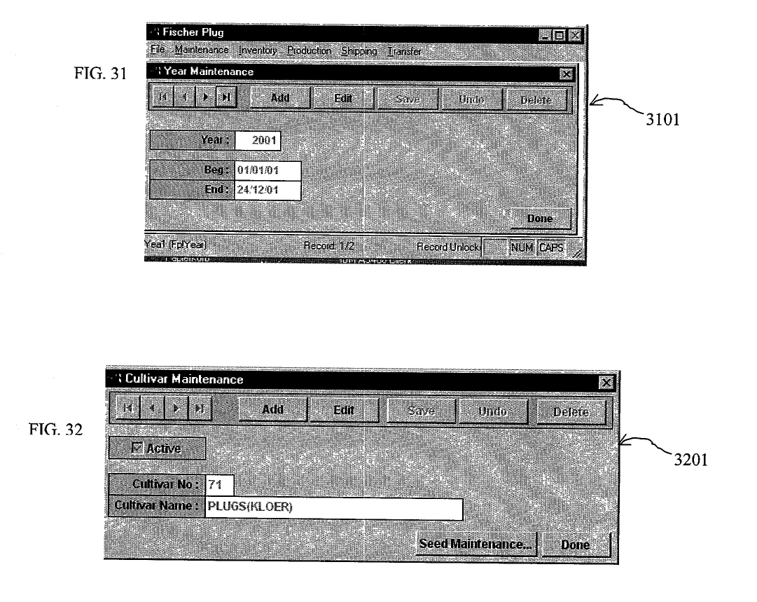

1. Year Maintenance (see screen 3101 in FIG. 31). This is needed to help the system determine the Monday dates for the Weeks. For example, when we enter 03/01 the system then knows that the Monday date for this week will be 15/01/2001. Enter the 1^{st} Monday date of the year and the last Monday date of the year. In the screen below the first Monday of the year (for week 01/01) 2001 is Jan. 1^{st}—the last Monday of the year (for week 52/01) 2001 is Dec. 24^{th}. This information must be absolutely correct as the entire system operates on the Monday date of the ship week/year! As a safety feature, if a non-Monday is entered the system will default to the prior Monday date.

2. Cultivar Maintenance (see screen 3201 in FIG. 32). For now, there should only be one Cultivar per plug system. For Kloer all plugs are under the cultivar 71. Note the checkbox called Active—this means the Cultivar 71 is a valid, working Cultivar for Kloer. When adding new items these should always be checked. There are features throughout the system that use this. For example, you can't add a Variety to a Production Plan if the Variety is not active.

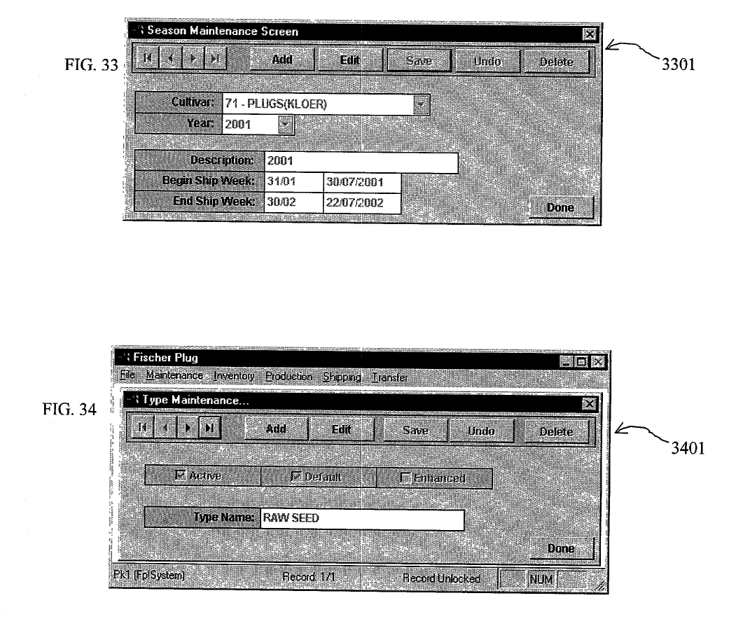

3. Season Maintenance (see screen 3301 in FIG. 33). Pick the Cultivar, Year, then type in a description of the Season and enter the first and last Ship Week of the Season.

4. Type Maintenance (see screen 3401 in FIG. 34). Currently there are 2 types of seed—Raw Seed and Pelleted Seed. Each variety can have Raw Seed or Pelleted or both. You can also establish a new type such as “Primed”. When the default is checked it means that the default Seed Type will be the Type selected. In this case, Raw Seed will be the default type.

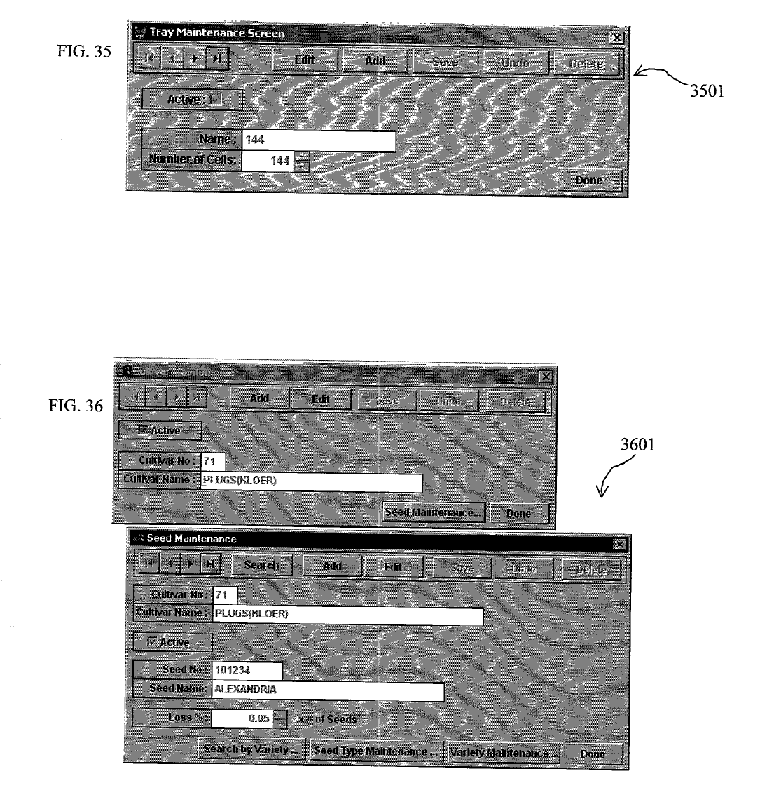

5. Tray Maintenance (see screen 3501 in FIG. 35). This establishes any tray size that is to be used (note the active box must be checked if it is a tray size that is to be used). If you are no longer using a particular tray size—simply remove the “Active” check from the box.

6. Seed Maintenance (see screen 3601 in FIG. 36). To get to seed maintenance you must first go to cultivar maintenance—then click on Seed Maintenance. The screen “Seed Maintenance” will come up. The “Seed No:” is a number assigned by the system to a particular variety of seed. If a new seed variety is added—the number will be automatically assigned. This seed variety can be used for one or more varieties of plugs depending on the tray size. The “Loss %:” refers to the percentage of Seed that will get lost during a Seeding cycle (spilled, extras picked up by the seeder, and just plain lost). This Loss % has nothing to do with over sow percentage—they are independent of each other.

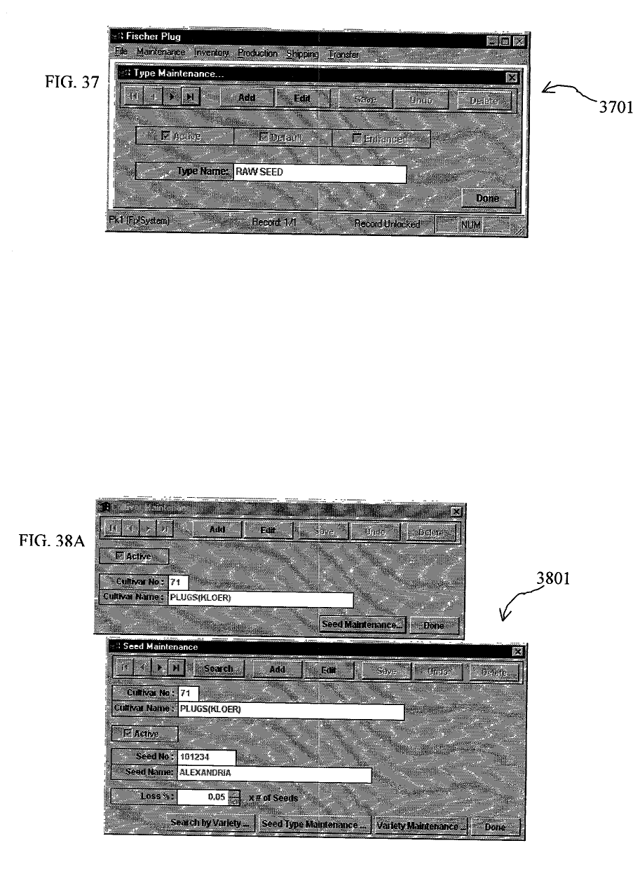

7. Seed Type Maintenance (see screen 3701 in FIG. 37). “Click” on the “Seed Type Maintenance” button on the screen above. When a new seed is added, the system automatically assigns the seed type that is set as the default (see Maintenance—Seed Type—item #2 above). If the seed type is something different than the default you must select it here. If there is more than one seed type that can be used then you must select the additional type by “Clicking” on the “Add” button and select from the pull down menu for “Type” the additional seed type. Select Seed Count 1—then “Click” on “Save”. If the type you seek is not in the pull down menu then you must go to the Seed Type Maintenance and add the Type required. This new type will now show up in the pull down menu. Whatever seed types are to be used for this variety must have the active box checked. You must select one as the default type.

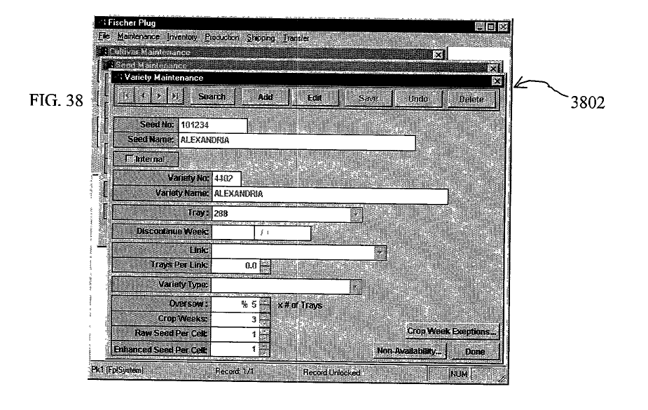

8. Variety Maintenance (see screens indicated by 3801 and 3802 in FIGS. 38A-B). To get to Variety Maintenance you must first “Click” on “Cultivar Maintenance” then “Click” on “Seed Maintenance” then “Click” on “Variety Maintenance”.

Some Varieties may be linked varieties—ones that are transplanted from a tray size that is sown (ie. A 288 tray) into the final Tray that will be sold (ie. A 72 tray). These must be marked as Linked, the Linked Variety(the one that is produced prior to this one) and the number of Trays per Link entered.

Oversow percentage is used to calculate how many additional Trays are needed to fill Orders. For example, if there are 27 Trays on Order and the Oversow percentage is 5.00% then we need 2 extra Trays for the Oversow. (27*0.05=1.35 rounded up to 2 Trays)

Note when we change the Over Sow, Crop Week, Seeds per Cell or Pellets per Cell, it starts using these changes on the next Production Week. This is based on whether or not the current one is completely Stuck or not.

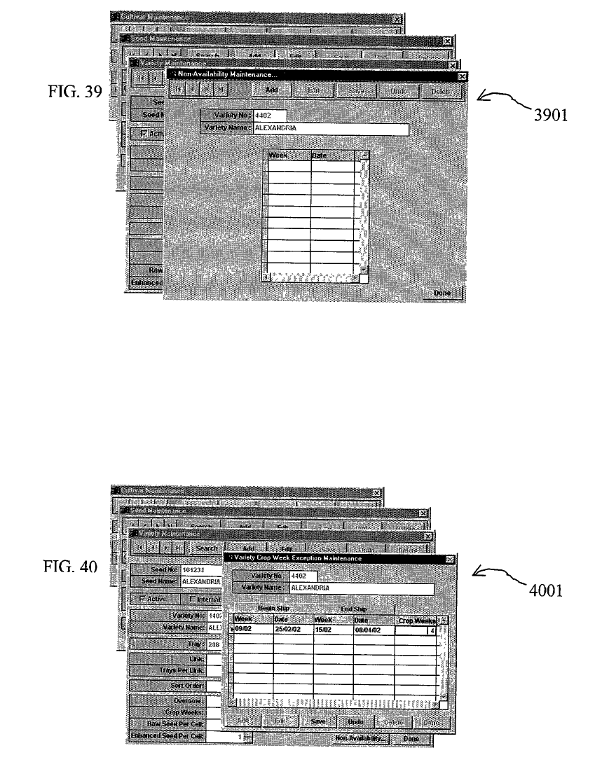

NON-AVAILABILITY (see screen 3901 in FIG. 39): Click on the “Non-Availability” button in the lower right to get the following pop-up screen. Click on the “Add” button and enter the week/year this variety will not be shipped. Multiple weeks can be entered. This is used primarily for the beginning and ending ship weeks of a season to consolidate volumes into every other ship weeks. Later, you will learn of a master screen where this can be done very quickly across multiple varieties and weeks.

VARIETY CROP WEEK EXCEPTIONS (see screen 4001 in FIG. 40): Each variety is set with a default for the production week crop time for that variety. Depending on the time of the year—some varieties will take either less time or more time to produce. Production times required are based on the ship weeks for the variety. Click on “Crop Week Exceptions” on the bottom right of the “Variety Maintenance” screen. Click on the “Edit” button and enter the range of ship weeks affected by the change in production weeks—then enter the production weeks required for this range of ship weeks—then click on “Save”. All weeks outside of the exception weeks will use the default weeks for calculating production, sow dates, and availability. When any changes are made—at the end of the day send “Inventory Transfer” to the Sales System.

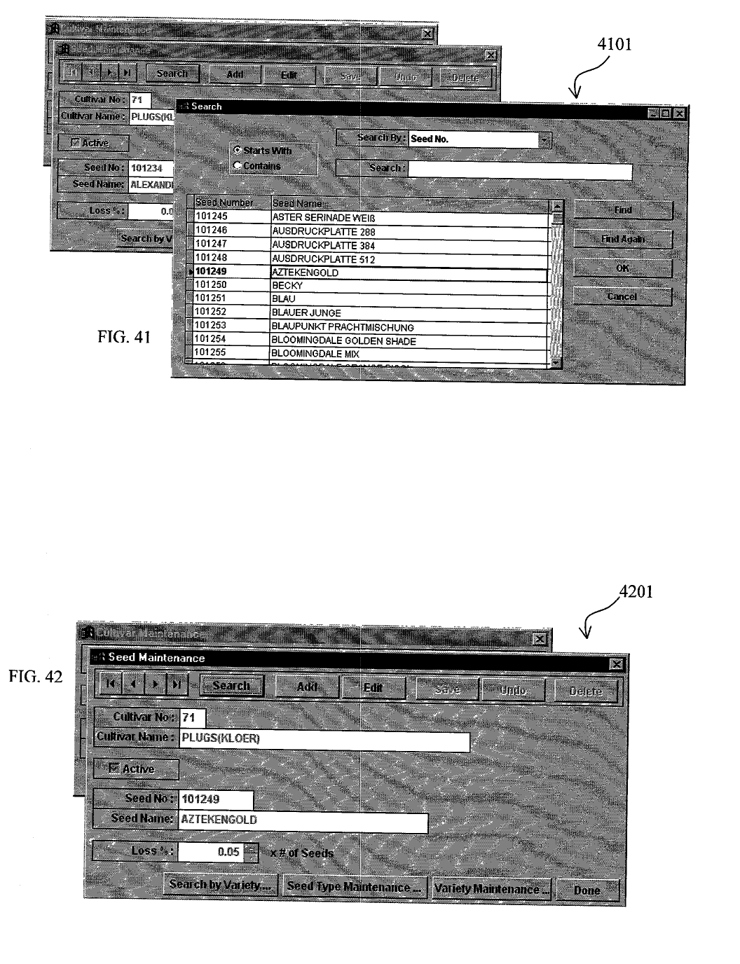

SEARCH FUNCTION (see screen 4101 in FIG. 41): Click on “Search” in the “Seed Maintenance” screen and the pop-up screen 4101 in FIG. 41 will appear. Use the pull down menu to quickly look up the variety in question. Highlight the variety you are looking for and click “OK”.

The screen 42901 shows your selection. Seed # 101249—AZTEKENGOLD:

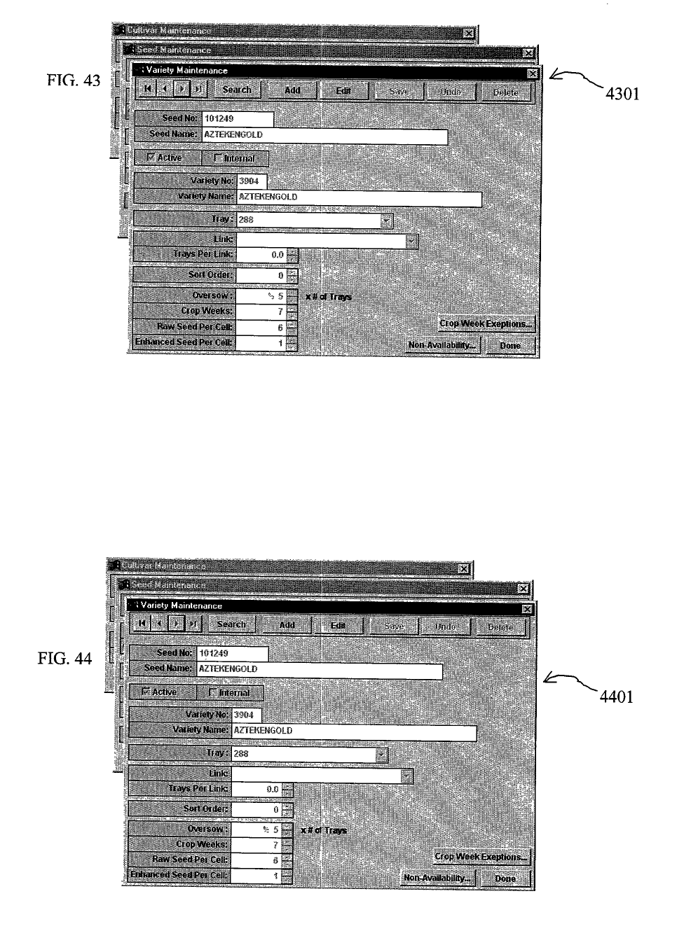

TO VIEW/EDIT/ADD PLUG VARIETIES (TRAY SIZES) (see screen 4301 in FIG. 43): Click on “Variety Maintenance” from the “Seed Maintenance” screen. Note the right seeking arrows in the upper left. The variety shown is # 3901—AZTEKENGOLD/384 Tray. To see the other varieties offered in this seed variety click on the “Right Arrow”.

Now you can see the other variety offered in this seed variety as a plug—# 3904—AZTEKENGOLD/288 Tray. (See screen 4401 in FIG. 44)

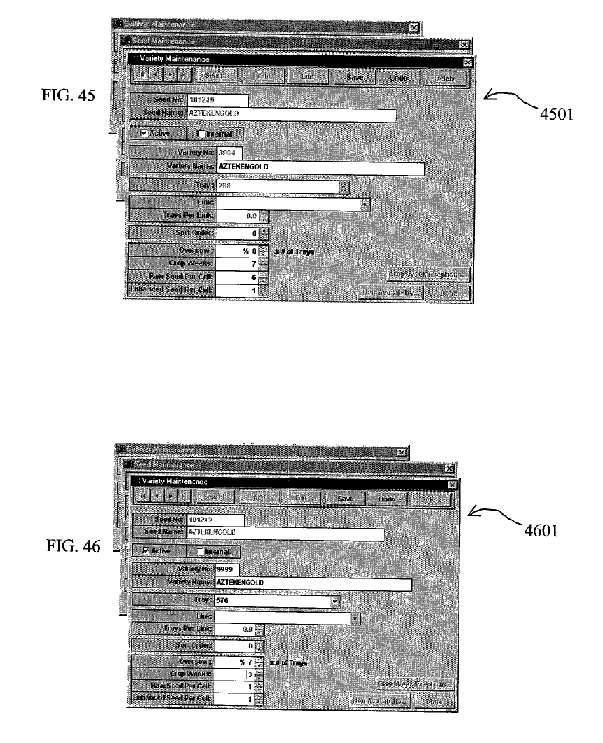

TO EDIT (see screen 4501 in FIG. 45): Click on the “Edit” button. Here you can edit the spelling, the sort order, oversow %, crop weeks, Raw Seed/cell, and enhanced seed/cell. After making changes click on “Save”.

TO ADD (see screen 4601 in FIG. 46): Click on the “Add” button. Enter variety # for the plug, variety name, select the tray size from the list, enter the sort order if there is one (this is not required), oversow %, crop weeks, raw seed per cell, and enhanced seed per cell. Click on “Save”.

After making changes or additions send “Inventory Transfer” to the Sales System.

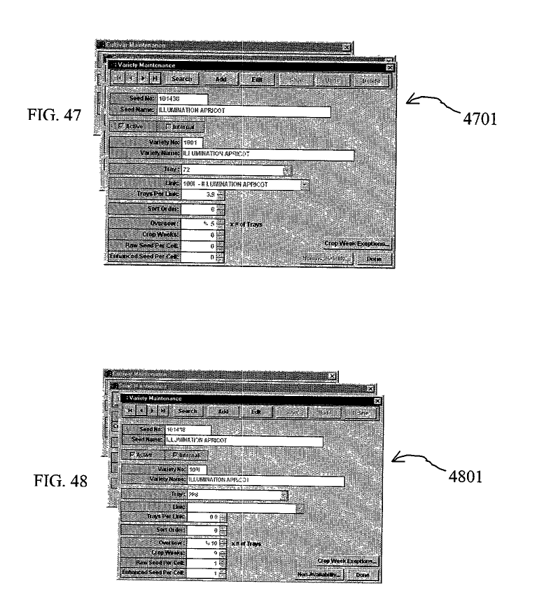

LINKED VARIETIES (see screen 4701 in FIG. 47): Some varieties offered go through a transplanting step such as the 72 Tray Non-Stops which are transplanted from the 288 Tray which is sown. We call these varieties that need transplanting “Linked”. The variety below, # 1001 ILLUMINATION APRICOT/72 Tray, is linked to the variety # 100L ILLUMINATION APRICOT/288 Tray. The 288 Tray takes 9 weeks to produce. The 72 Tray takes 6 weeks to produce after transplant. Total production time is 15 weeks.

To create the link, have the variety you wish to link to showing on the screen (var. # 1001 ILLUMINATION APRICOT/72 Tray). (See screen 4801 in FIG. 48.) Click on the “Add” button (here you will be adding a new variety of plug tray of the same seed variety as the 72 Tray shown above). Make sure the “Active” box is checked—also for this variety check the “Internal” box (as this will only be used internal transplanting). Enter production weeks, oversow %, and seeds per cell.

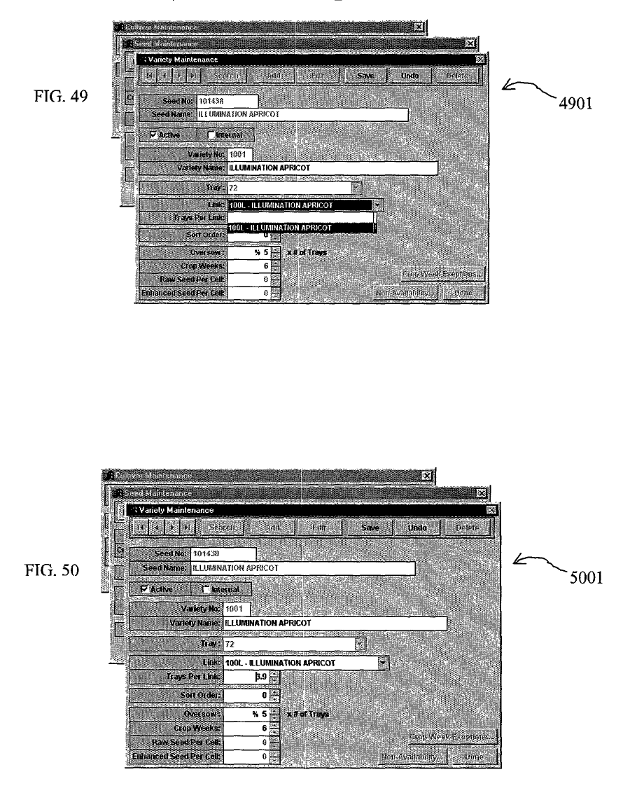

Click on “Edit” (see screen 4901 in FIG. 49)—then select from the pull down menu the linked variety you just created (note when you do this the seeds per cell goes away).

Enter the number of “Trays Per Link” (how many 72 trays do you expect to transplant from each 288 tray?). (See screen 5001 in FIG. 50.) In the example below we have selected 3.9 trays.

“Click” on “Save”. You have now created a linked tray of 288's that will be sown 15 weeks prior to shipping of the 72 tray. A transplant list will be created the week before transplanting.

VARIETY CROP WEEK EXCEPTIONS (see screen 5101 in FIG. 51): Select the “Cultivar” the click on “Grid”. Any varieties you have previously created “Crop Week Exceptions” for will show up in this screen. You can edit what you have done by clicking on “Edit”. You can also use this screen to quickly input the variety crop week exceptions—directly. To enter “Crop Week Exceptions” in this screen—click on the “Edit” button—then click on the “Add” button.

Select from the pull down menu the variety you wish to edit. (See screen 5201 in FIG. 52.)

Click on “OK”

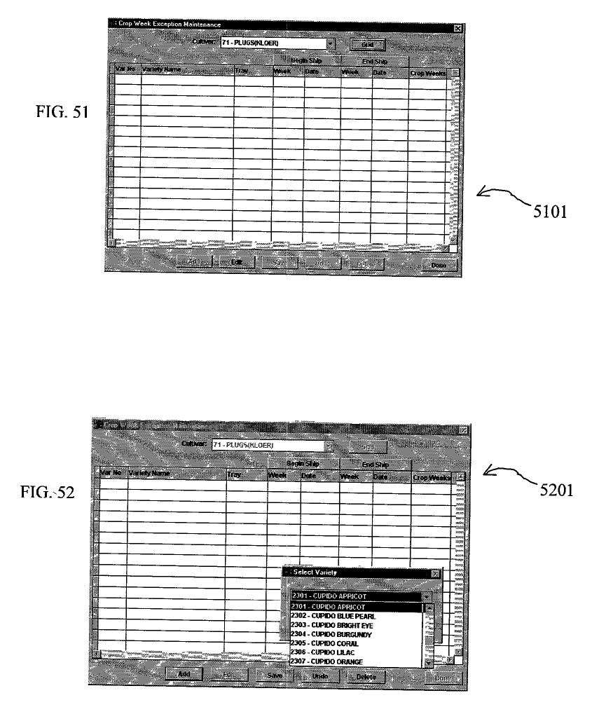

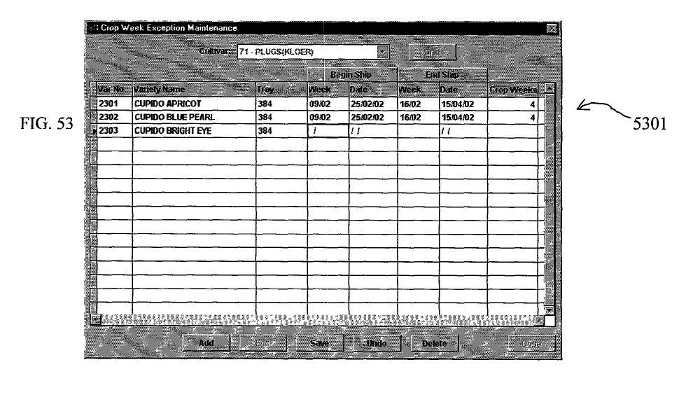

Add in the appropriate information—then click on “Save”. (See screen 5301 in FIG. 53.)

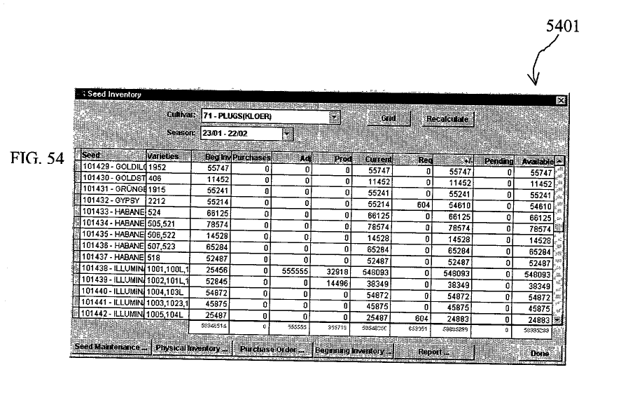

INVENTORY (see screen 5401 in FIG. 54): This screen shows the status of available seed. 1.) The Seed Item Number and name, 2.) the varieties of plugs (trays) associated with the seed item, beginning inventory, 3.) Purchases (purchase orders that have been received), 4.) Adjustments (changes in inventory due to a physical inventory), 5.) Production (how many seeds have been used up in sowing), 6.) Current (what is left in inventory after sowing), 7.) Required (what quantity of seed is need to sow orders in house—not yet produced), 8.) (+/−) the result of Current less Required, 9.) Pending (any quantities on a purchase order not yet received or past the expected arrival date), and 10.) Available (the result of (+/−) plus Pending.

From this screen you can go into 1.) Seed Maintenance, 2.) enter a Physical Inventory, 3.) enter, edit, or receive a Purchase Order, 4.) enter a Beginning Inventory for the new season, 5.) print a Report showing the status of the seed.

Any changes made in Inventory must be passed on to the Sales System via an Inventory Transfer!

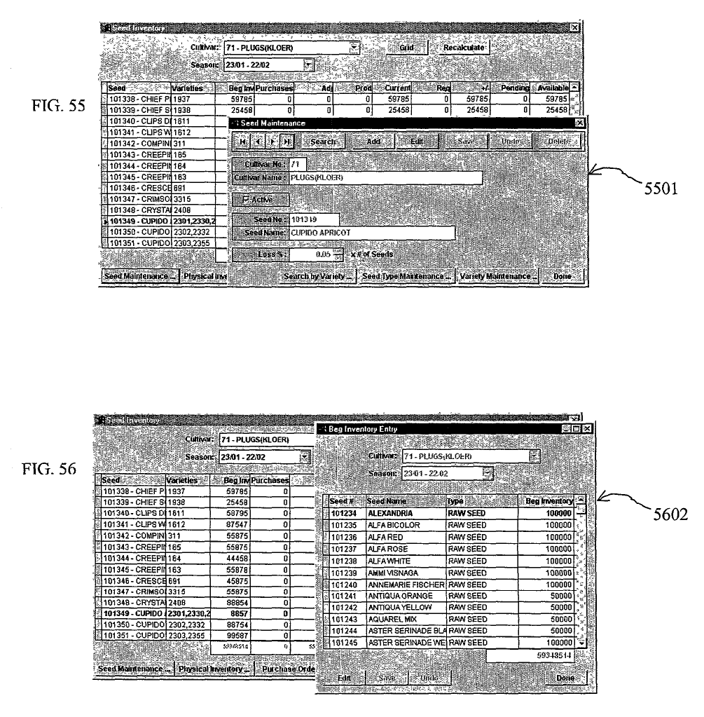

INVENTORY/SEED MAINTENANCE (see screen 5501 in FIG. 55): Highlight the variety you are interested in—then click on “Seed Maintenance”. You will get the following screen. Consult previous instructions on how to navigate within this screen.

INVENTORY/BEGINNING INVENTORY (see screen 5601 in FIG. 56): Having selected the Cultivar and the Season in the Seed Inventory screen—click on “Beginning Inventory” and the following pop up screen will appear. Here you can enter or edit your beginning inventory.

After entering or editing your Beginning Inventory—transfer Inventory to the Sales System!

INVENTORY/PHYSICAL INVENTORY (see screen 5701 in FIG. 57): At any time you can do a Physical Inventory of one, several, or all of your seed varieties. This will be necessary because the system uses assumptions in how it allocates seed to production. The Physical Inventory is the method to verify current inventories. From the Seed Inventory screen click on “Physical Inventory” and you will see the following screen:

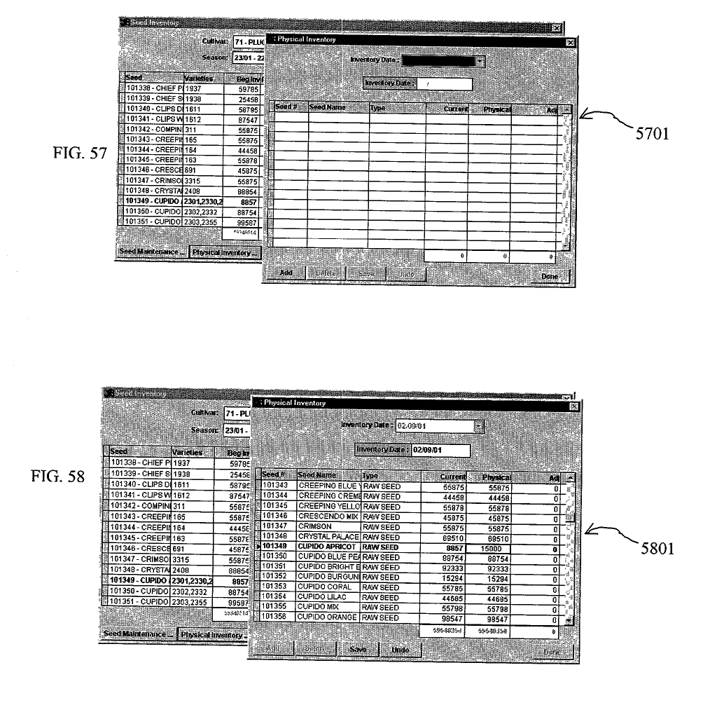

Click on “Add”—the date will automatically fill in with today's date and the physical inventory will fill in with what the system has calculated to be current inventory. Simply correct the figures in the column “Physical Inventory” with the correct quantities and “Save”. Below I have corrected Cupido Apricot's inventory with 15.000 seed. (See screen 5801 in FIG. 58.)

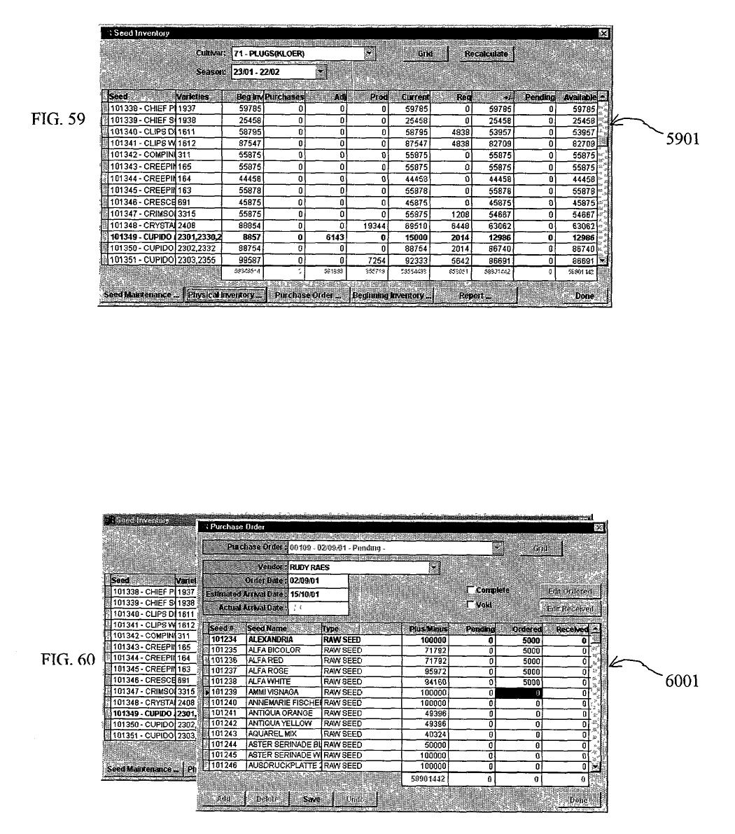

The screen (see screen 5901 in FIG. 59) shows the result of the Physical Inventory after saving.

The results of the physical inventory shows up in the “Adjustments” column. For Cupido Apricot this is 6.143 seeds (the difference between physical inventory 15.000 seeds and beginning inventory 8.857 seeds). After any Physical Inventory is completed be sure and transfer “Inventory” to the sales system.

INVENTORY/PURCHASE ORDER (see screen 6001 in FIG. 60): All seed ordered must be entered on the PLUG SYSTEM—Purchase Order Feature. This is the only way to keep inventory up-to-date for the Sales System.

Click on “Purchase Order”—then click on “Add” to create a new purchase order. The purchase order date will automatically fill in with today's date and say “Pending”. You need to select the “Vendor” and fill in the “Estimated Arrival Date”. Then simply fill in the quantity of seeds you want to order and click on “Save”.

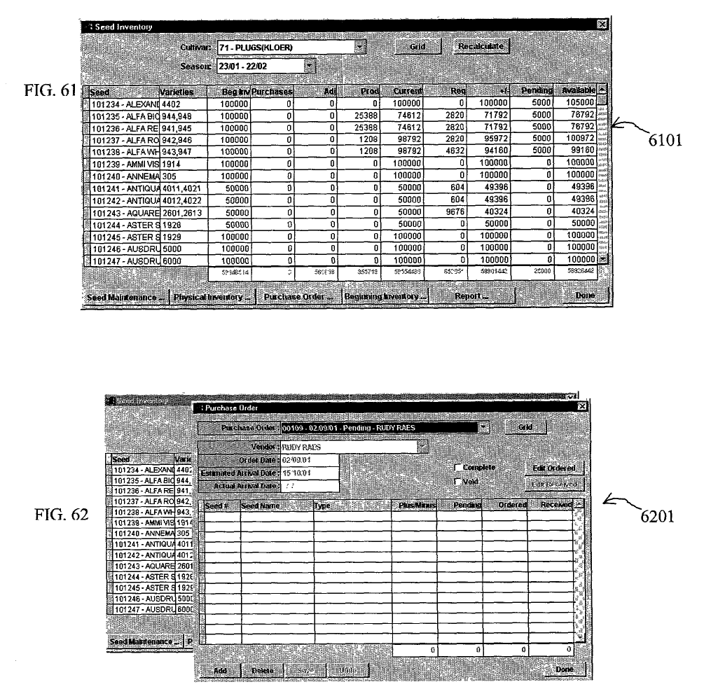

You can see in the Inventory Screen the impact of creating this “Purchase Order” in the “Pending” column (see screen 6101 in FIG. 61). These quantities add to the totals in the “Available” column. When this new inventory is transferred to the Sales System it will be possible to place orders against these new totals.

It is possible to edit purchase orders. Click on “Purchase Orders”—select the purchase order you want from the pull down list—then click on “Grid”. (See screen 6201 in FIG. 62.)

This will bring up your purchase order (see screen 6301 in FIG. 63)

Now you can edit the original order “Edit Ordered” or receive part or all of the order “Edit Received”. To receive part of this order click on “Edit Received”. First you must fill in the actual arrival date—then you can enter what is received. (See screen 6401 in FIG. 64)

Because we are only receiving part of this order—when the “Save” button is clicked, a pop-up window comes up and you must answer one of the 4 questions. In this case we are going to say “Make a New Order”—then click “OK”.

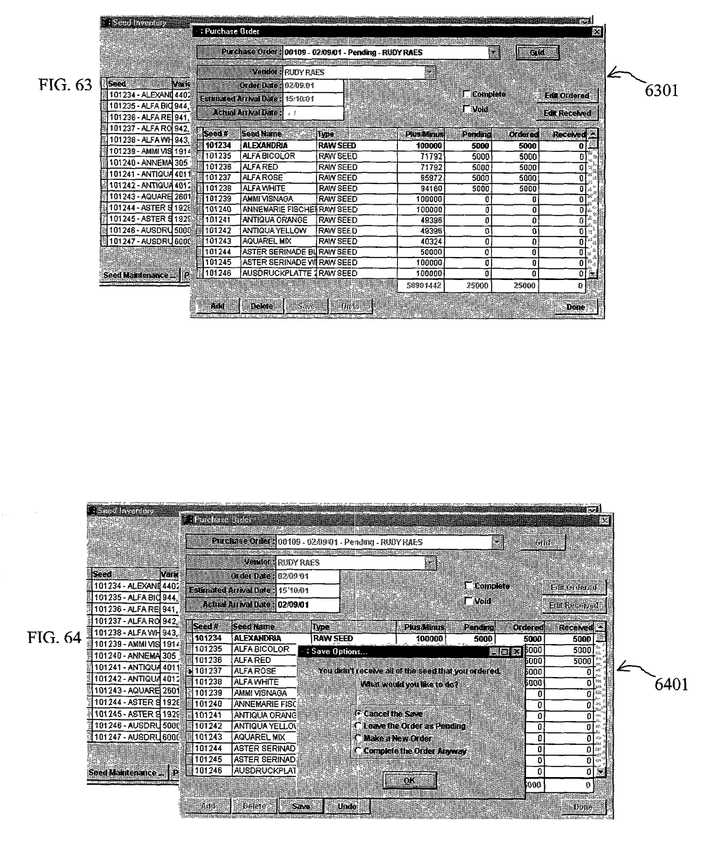

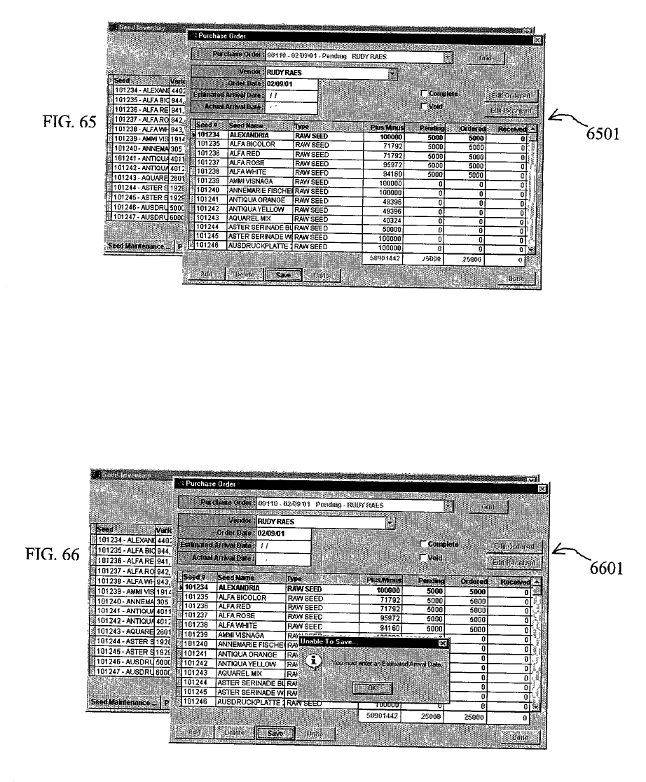

You get the following screen (see screen 6501 in FIG. 65)—you must enter the “Estimated Arrival Date” for the new purchase order you have created (all of the seed you did not check in as arriving from the original purchase order)—then click on “Save”.

The following screen (see screen 6601 in FIG. 66) shows what happens if you do not enter the new arrival date.

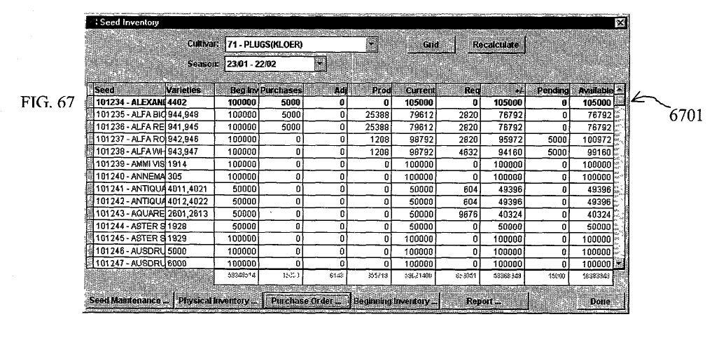

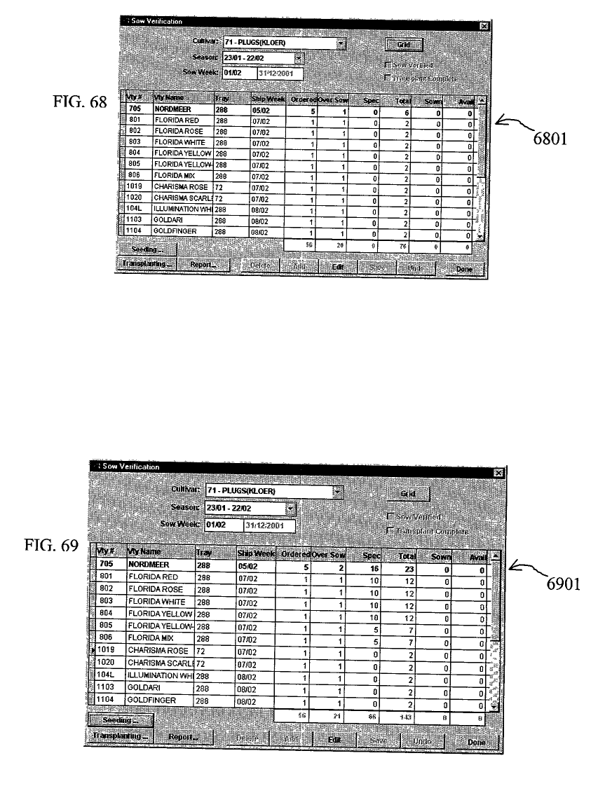

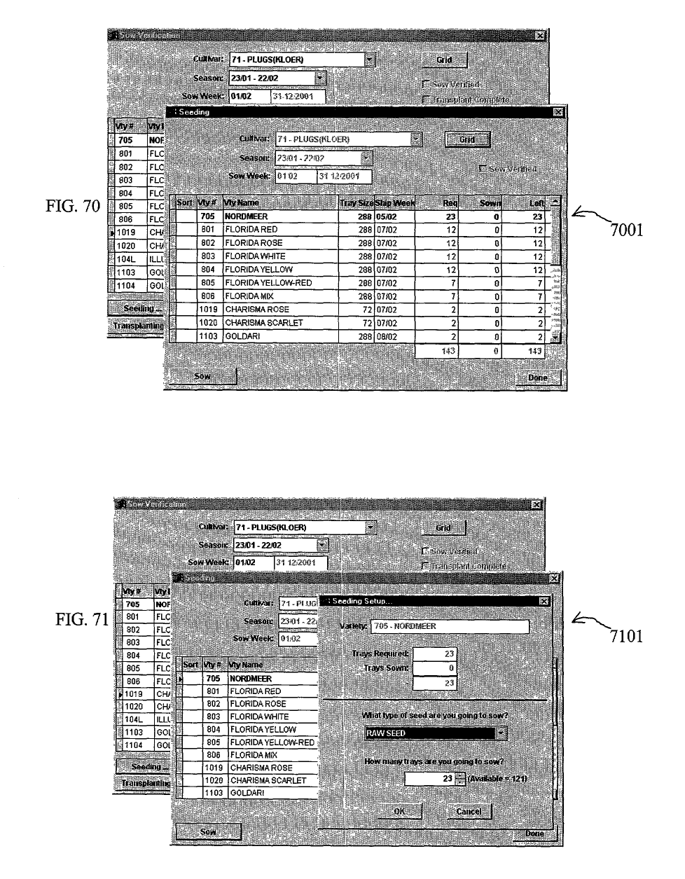

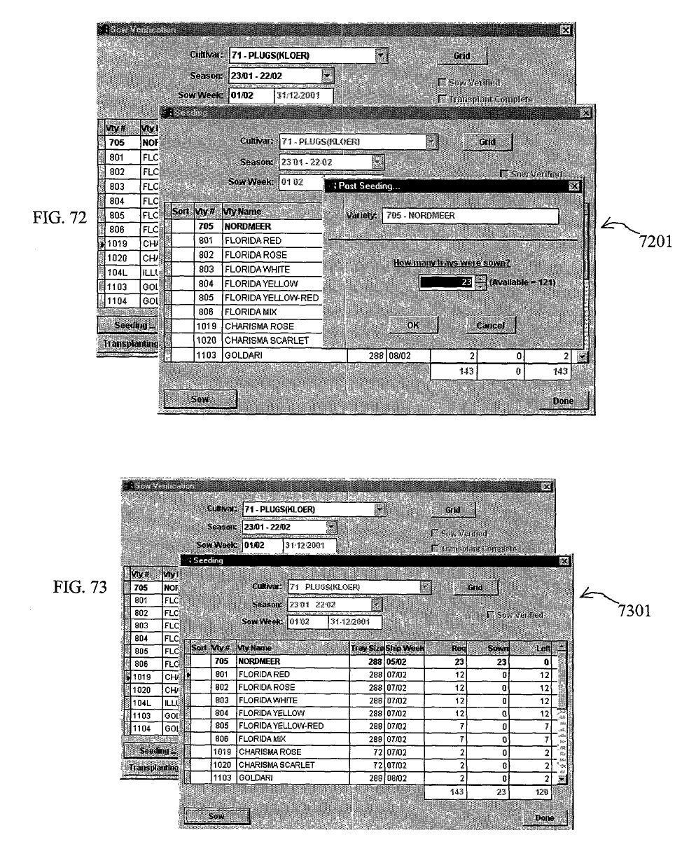

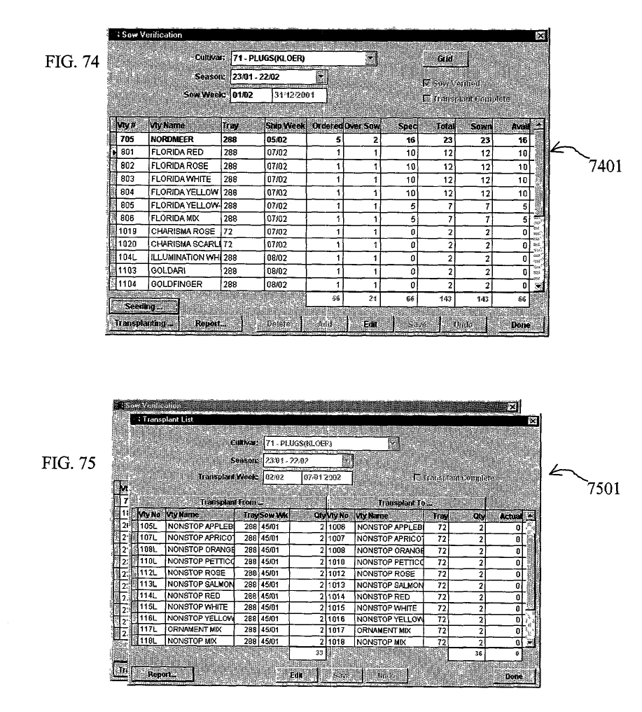

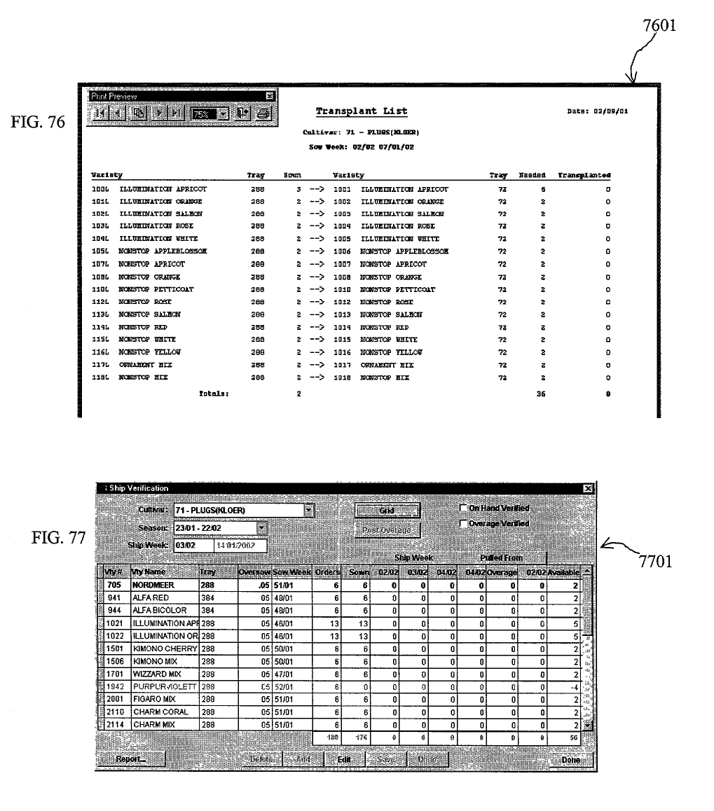

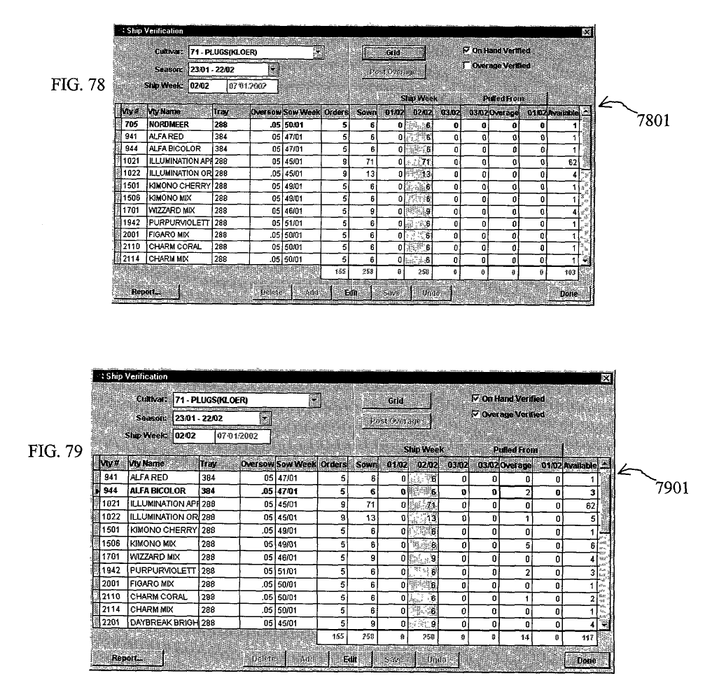

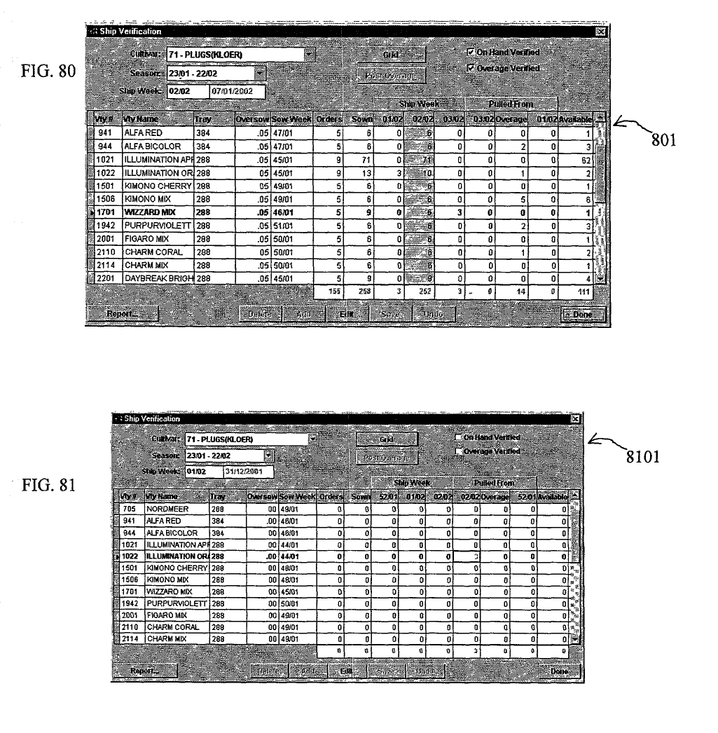

The screen (see screen 6701 in FIG. 67) is what you see if done correctly.

The quantities for the three varieties of seed we received now show up in the “Purchases” column and no longer show up in the “Pending” column.

The new Purchase Order you created now has only those items that were not received.

PRODUCTION: This section of the menu is where all sow verifications and ship verifications are done as well as where speculation is done.

PRODUCTION/SOW VERIFICATION: Enter the Cultivar, Season, and the Sow Week—then click on “Grid”. You will see the 1.) varieties alphabetical by tray size, 2.) the tray size, 3.) the ship week for the variety/tray size for this sow week, 4.) the quantity on order, 5.) the calculated oversow 6.) a column for speculation, 7.) the total to sow which is the sum of Ordered+Oversow+Speculation, 8.) Sown—the quantity actually sown, and 9.) Available—the quantity available to sell after speculation is sown and verified.

Click on “Edit” to enter speculation. After all speculation is entered click on “Save”.

You can see we have speculated in the first 7 items of the list. In the first item our speculation of 16 trays caused another tray to be calculated for the oversow.

SEEDING: To do the seeding click on “Seeding” and you will get the following screen:

Highlight the variety you will be sowing and click on “Sow”

In the bottom half you can select what type of seed you are going to use, the number of trays you want to sow. You can also see the quantity of trays you can sow based on available seed (future orders are protected so that you do not over-sow with your speculation). Click “OK” that you intend to sow all 23 trays.

Then you will see the next pop-up screen. In this screen you verify that indeed you did sow all 23 trays.

Click on “OK”.

Once the entire sow week is completed you must check the “Sow Verified Box”. This will post the speculation. Note the running totals at the bottom.

The following screen shows the entire sow week as verified.

AFTER COMPLETING THE SOW WEEK AND CHECKING “SOW VERIFIED” YOU MUST TRANSFER “PRODUCTION” TO THE SALES OFFICE.

TRANSPLANTING: Linked products will show up here in the weeks they are to be transplanted. Click on “Transplanting—” from the “Sow Verification” screen to get the following screen.

When transplanting is done you need to enter on this screen the actual amount transplanted. Click “Edit” to enter amounts.

TRANSPLANT REPORT: You can get a Transplant Report for the week by clicking on “Report”.

PRODUCTION/SHIP WEEK VERIFICATION: 10 days before the ship week enter the shippable quantities of trays on hand in the Ship Week column 03/02 from the sow week sown. Overages from the ship week prior are entered in the Overage column

Click on “Edit” to enter quantities—then click on “Save”.

The following screen shows all of the information entered for ship week 02/02. Note—the “On Hand Verified” box has been checked after all of the quantities have been entered. If there is a zero (0) in one of the cells for the ship week by checking the on hand verified box it will calculate as a zero.

After verifying the ship week transfer production to the Sales System!

POSTING OVERAGE: Posting the overage immediately after the ship week is very important if there is any hope of it selling. After overage is completely posted—check the “Overage Verified” box. This will tell the system to calculate all of the zero's as zero's.

After overage has been entered you must transfer Production to the Sales System.

PULLING AHEAD AND PUSHING OFF: It is possible to pull trays for an earlier ship week to make up for shortages or to push off to a later ship week (if the crop won't be ready for the planned ship week. It is important to enter all of the “Pushes” and “Pulls” into the system to keep the inventory straight!!!! In the following example we have pulled 3 trays early of variety #1022 to ship in week '01/02 and we have pushed off 3 trays of variety #1701 to ship in week 03/02. This reduces “Available” in ship week 02/02.

In ship week 01/02 you can see the trays we pulled early.

If you pull or push you must send a production transfer to the sales system!

In ship week 03/02 you can see the trays we pushed off.

Send Production Transfer to the Sales System!

UNEXPECTED LOSSES: If you have an unexpected loss—record it immediately (do not wait for the 10 day prior to ship to verify the loss). One week after sowing 23 trays of variety #705 there was a heavy rain and all but 2 trays were lost. Enter this loss immediately. You will note that we are now short 3 trays for orders. Transfer “Production” to the “Sales System” so that Sales can notify the customers and fix the orders!

Send Production Transfer to the Sales System!

PRODUCTION REPORT: The production report shows the state of the inventory of plug trays relative to the orders over a 4 week period with a calculation of the (+/−) for the week and a total of the sums of the (+/−)'s for the 4 week period.

Production: Space Report—Based on your space allocated in the “Sow Week” screen in “Maintenance” and the calculation of the space required for the orders you are able to get a visual presentation of the space utilization in your greenhouse:

You will get the following graph:

Production: Trays Required—

If you enter more than 8 weeks at a time you will get the following message:

With 8 weeks you will get the following report:

This report does show totals to the right of this screen.

THIS IS THE END OF THE PRODUCTION SECTION.

SHIPPING: Delivery Notes—You can generate Delivery Notes only once.

Generate after final download of orders for the ship week

Orders after this download will be sent as late orders.

If a sow week that impacts this delivery week is not complete—you will get the above message. Go back to sow week 47/01 and complete

After generating—you can see the tours that have been created

You can view the delivery notes by tour.

You can move orders from one tour to another. Highlight “Dusseldorf” and “Click” on Tour Details. “Click” on Move.

Select “Default—this order will be moved—then click OK

By clicking on “JA” you will delete this tour that now has no orders

Tour “Dusseldorf” is now gone

By going to the Default Tour you can now see the order in this tour

The next step is to organize the ship week. You do this from the Tours screen. Simply check the day of the week the tour will leave your location. First click Edit—after checking the proper boxes—click on Save

Now you can go into the tour and organize the drop sequence.

You can organize the drops by clicking on SEQ. Enter the License for the truck and for the trailer.

It should be appreciated that many other similar configurations are within the abilities of one skilled in the art and all of these configurations could be used with the methods of the present invention. Furthermore, it should be recognized that the computer system and network disclosed herein can be programmed and configured as networked computer system components, by one skilled in the art, to implement the method steps discussed herein.

Other embodiments of the invention will be apparent to those skilled in the art from a consideration of the specification and the practice of the invention disclosed herein. It is intended that the specification be considered as exemplary only, with the true scope and spirit of the invention also being indicated by the following claims.

What is claimed is:

1. A computer implemented method of tracking inventories of a time period sensitive item on a time period basis, the method comprising the steps of:
establishing demand for the time period sensitive item for each time period in a time interval;
establishing a production plan for producing a source item that produces the time period sensitive item for each time period in the time interval, wherein the source item generates the time period sensitive item over various time periods in the time interval; and
reserving time period sensitive items for the established demand on a time period basis.

2 The computer implemented method according to claim 1, wherein the time period sensitive item comprises a vegetative cutting and the source item comprises a stock plant.

3. The computer implemented method according to claim 1, wherein the time period sensitive item comprises a plug seedling and the source item comprises a seed.

4. The computer implemented method according to claim 2, further comprising the steps of:
determining time period based availability of cuttings from the stock plants; and
determining a production period for rooted stock plant, wherein the production plan is calculated by factoring in the time period based availability of cuttings and the production period for the rooted stock plant cuttings.

5. The computer implemented method according to claim 4, wherein the step of determining the time period based availability of cuttings from the stock plant comprises the steps of:
determining an initial production index value representing number of cuttings available per stock plant for each time period; and
adjusting the production index value for a time period based on observed or calculated parameters related to the stock plant or growth environment associated with the stock plant.

6. The computer implemented method according to claim 5, wherein the step of determining the time period based availability of cuttings from the stock plant further comprises:
using a security factor or percentage to buffer the time period based availability of cuttings from the stock plant.

7. The computer implemented method according to claim 2, wherein the step of reserving time period sensitive items for the established demand on a time period basis comprises:
receiving orders for the time period items; and
automatically spreading the orders to farms based on logic rules.

8. The computer implemented method according to claim 7, wherein the step of automatically spreading order to farms based on logic rules comprises in sequence the following steps:
allocating orders to farms based on farm priorities of a sales office associated with the order;
allocating unrooted cuttings corresponding to all rooted cuttings to be rooted at a farm to that farm;
allocating orders to farms based on farm priorities of customers of the orders;
allocating orders to a farm in a priority sequence from a smallest order to a largest order to avoid splitting the smaller orders; and
spreading production orders from the rooting stations.

9. The computer implemented method according to claim 2, wherein the step of establishing a production plan comprises correlating the stock plants to actual physical locations in a farm and specifying the variety, type, and quantity of the stock plants.

10. The computer implemented method according to claim 9, wherein the step of establishing a production plan further comprises providing a buffer to allow for variation in the yield of the cuttings from the stock plants.

11. The computer implemented method according to claim 2, further comprising the step of adjusting the production plan by verifying actual plantings of the stock plants and comparing with planned plantings of the stock plants.

12. The computer implemented method according to claim 11, further comprising the step of generating a cut list at a farm to facilitate cutting and shipping of cuttings from the stock plants.

13. The computer implemented method according to claim 12, further comprising the steps of:
receiving claims against defective cuttings; and
correlating the defective cuttings to the farms on which the cuttings were produced.

14. The computer implemented method according to claim 4, wherein the step of determining a production period for stock plant cutting comprises determining multiple production periods for varieties of stock plant cuttings that need to be rooted.

15. The computer implemented method according to claim 4, further comprising the step of warehousing rooted stock plant cuttings in a dormant state to vary the production period of the rooted stock plant cutting.

16. The computer implemented method according to claim 3, wherein the step of establishing a production plan for the plug seedlings comprises coupling the production of the plug seedlings to a seed inventory for the plug seedlings.

17. The computer implemented method according to claim 16, wherein the seed inventory comprises a combination of seed on hand and expected arrival dates of purchased seeds.

18. The computer implemented method according to claim 16, further comprising the steps of:
calculating a quantity of an initial form of plug seedlings developed from seeds based on a desired quantity of a final form of plug seedlings; and
determining transplanting conditions that link the initial form of the plug seedlings to the final form of the plug seedlings.

19. The computer implemented method according to claim 18, wherein the initial form of plug seedlings comprises a 288 tray and the final form of the plug seedlings comprises a 72 tray.

20. An inventory control system for tracking inventories of a time period sensitive item on a time period basis, comprises:
a sales system processing unit configured to establish demand for the time period sensitive item for each time period in a time interval;
a farm system processing unit configured to establish a production plan to generate a source item that produces the time period sensitive item for each time period in the time interval, wherein the source item generates the time period sensitive item over various time periods in the time interval; and
a main system processing unit configured to reserve the time period sensitive items for the established demand on a time period basis.

21. The inventory control system according to claim 20, wherein the time period sensitive item comprises a vegetative cutting and the source item comprises a stock plant.

22. The inventory control system according to claim 20, wherein the time period sensitive item comprises a plug seedling and the source item comprises a seed.

23. The inventory control system according to claim 21, wherein the farm system processing unit is configured to determine the time period based availability of cuttings from stock plants, and a rooting station processing unit is configured to determine a production period for rooted stock plant cuttings, and wherein the production plan is calculated by factoring in the time period based availability of cuttings and the production period for rooted stock plant cuttings.

24. The inventory control system according to claim 23, wherein the farm system processing unit determines the time period based availability of cuttings from the stock plant by determining an initial production index value representing number of cuttings available per stock plant for each time period, and adjusting the production index value for a time period based on observed or calculated parameters related to the stock plant or growth environment associated with the stock plant.

25. The inventory control method according to claim 24, wherein the farm system processing unit uses a security factor or percentage to buffer the time period based availability of cuttings from the stock plant.

26. The inventory control system according to claim 21, wherein the main system processing unit reserves the time period sensitive items for the established demand by receiving orders from the sales system processing unit and automatically spreads the orders to the farm system processing unit based on logic rules.

27. The inventory control system according to claim 26, wherein logic rules comprise allocating based on the following sequential rules:
allocating orders to farms based on farm priorities of a sales office associated with the order;
allocating unrooted cuttings corresponding to all rooted cuttings to be rooted at a farm to that farm;
allocating orders to farms based on farm priorities of customers of the orders;
allocating orders to a farm in a priority sequence from a smallest order to a largest order to avoid splitting the smaller orders; and
finally spreading production orders from the rooting stations.

28. The inventory control system according to claim 21, wherein the farm system processing unit establishes the production plan to include a correlation of stock plants to actual physical locations in a farm and specifies the variety, type, and quantity of the stock plants.

29. The inventory control system according to claim 21, wherein the farm system processing unit is configured to receive verified actual plantings of stock plants and adjusts the production plan based on a comparison of the actual plantings to the planned plantings of the stock plants.

30. The inventory control method according to claim 22, wherein the farm system processing unit establishes the production plan by coupling the production of the plug seedlings to a seed inventory for the plug seedlings.

31. The inventory control system according to claim 30, wherein the farm system is configured to calculate a quantity of an initial form of plug seedlings developed from seeds based on a desired final form of the plug seedlings, and determining a transplanting schedule that links the initial form of the plug seedlings to the final form of the plug seedlings.

32. A computer readable medium having computer program code recorded thereon, the computer program code configured to cause a computing system to perform the following steps:
establishing demand for the time period sensitive item for each time period in a time interval;
establishing a production plan for producing a source item that produces the time period sensitive item for each time period in the time interval, wherein the source item generates the time period sensitive item over various time periods in the time interval; and
reserving time period sensitive items for the established demand on a time period basis.

33. The computer readable medium according to claim 32, wherein the time period sensitive item comprises a vegetative cutting and the source item comprises a stock plant.

34. The computer readable medium according to claim 32, wherein the time period sensitive item comprises a plug seedling and the source item comprises a seed.

35. An inventory control system for tracking inventories of a time period sensitive item on a time period basis, comprising:
means for establishing demand for the time period sensitive item for each time period in a time interval;
means for establishing a production plan for producing a source item that produces the time period sensitive item for each time period in the time interval, wherein the source item generates the time period sensitive item over various time periods in the time interval; and
means for reserving time period sensitive items for the established demand on a time period basis.
